(19) United States
(12) Patent Application Publication
(10) Pub. No.: US 2018/0342028 A1
(43) Pub. Date: Nov. 29, 2018

(54) FIRST RESPONDER INFORMATION SYSTEM

(71) Applicant: LOCALITY MEDIA, INC., Garden City, NY (US)

(72) Inventors: Andreas Huber, New York, NY (US); Rami El-choufani, Marina Del Rey, CA (US); Edward Stempinski, Burlington, NJ (US)

(21) Appl. No.: 15/603,808

(22) Filed: May 24, 2017

(51) Int. Cl. G06Q 50/26; G06F 17/30; G06F 3/0481; G08B 25/00

(52) U.S. Cl. CPC G06Q 50/26; G06F 17/30994; G06F 3/0485; G08B 25/006; G06F 3/04817

(57) ABSTRACT

Systems, methods, and computer-readable media for providing information to first responders during an emergency response include a processor, a display device, and a memory. The memory stories instructions that, when executed by the processor, cause the system to obtain, from a plurality of data sources over a communication network, data related to a geographical address. The obtained data is normalized based on a normalization rule. The normalized data is processed including to identify, based on at least one of a predetermined criterion or the normalized data, a user interface element to include in a user interface. Based on a result of the processing, the user interface including the user interface element is generated and displayed by way of the display device.

### BACKGROUND

### Field

This disclosure relates generally to emergency response information management, and, more particularly, to systems, methods, and computer-readable media for providing information to first responders during an emergency response.

### Related Art

Each year, thousands of first responders and civilians are injured or killed during emergency responses for a variety of reasons. In at least some instances, the injuries or deaths could have been avoided if certain information were made available to the first responders. Unfortunately, using conventional systems, first responders have limited access to information that they may find relevant to an emergency response. Moreover, in many cases, information that first responders are provided with is outdated, incomplete, and ineffective information that was manually collected in an inefficient manner prior to the emergency. Further, information that is provided to first responders is not presented in a consumable manner that enables first responders to quickly absorb the relevant information and take the appropriate action as necessary in circumstances where mere seconds can often mean the difference between life and death. In view of the foregoing, it would be beneficial to have a system that provides first responders with up-to-date information that is relevant to an emergency response and that is presented in a manner that enables the first responders to absorb the information and take appropriate action in an expedient manner.

### SUMMARY

In one aspect of this disclosure, a system for providing information to first responders during an emergency response is described. The system includes a processor, a display device, and a memory. The memory stores instructions that, when executed by the processor, cause the system to obtain, from a plurality of data sources over a communication network, data related to a geographical address. The obtained data is normalized based on a normalization rule. The normalized data is processed to identify, based on at least one of a predetermined criterion or the normalized data, a user interface element to include in a user interface. Based on a result of the processing, the user interface including the user interface element is generated and displayed by way of the display device.

In embodiments, the obtained data includes a plurality of data fields each having a corresponding plurality of data field values, and normalizing the obtained data includes extracting the plurality of data field values from the obtained data, and, based on the normalization rule, modifying the plurality of data field values, thereby generating a plurality of normalized data field values.

In embodiments, the predetermined criterion includes a rule that indicates, based on a data field value of a data field included in the obtained data, whether to include a user interface element in the user interface.

In embodiments, the user interface includes a textual description of a structure located at the geographical address. The textual description may include at least one of a number of floors of the structure, a date of construction of the structure, a material of which the structure is constructed, or an indication of whether the structure includes a solar panel.

In embodiments, the user interface includes a plurality of alert icons, each alert icon belonging to a one of a plurality of alert icon categories and providing an alert corresponding to a structure located at the geographical address.

In embodiments, the plurality of alert icon categories includes at least one of an occupancy category, a consideration category, a building construction category, a pre-plan category, a fire suppression category, or a hazard category.

In embodiments, alert icons belonging to the occupancy category include an alert icon indicating an occupancy of the structure; alert icons belonging to the consideration category include at least one of an alert icon indicating whether the structure includes a solar panel or an alert icon indicating whether a swimming pool is located at or near the structure; and alert icons belonging to the building construction category include at least one of an alert icon indicating whether the structure is formed of a truss construction, an alert icon indicating whether the structure is formed of concrete, or an alert icon indicating whether the structure includes roofing material.

In embodiments, alert icons belonging to the pre-plan category are generated based on data obtained from a pre-planning source; alert icons belonging to the fire suppression category include an alert icon corresponding to a sprinkler installation at the structure; and alert icons belonging to the hazard category include an alert icon indicating whether any hazardous material is present at or near the structure.

In embodiments, each of the plurality of alert icons is color coded based on which one of the plurality of alert icon categories to which it corresponds.

In embodiments, the user interface includes a plurality of selectable visual user interface elements, including at least one of a street view user interface element, a roof image user interface element, a property sketch user interface element, a hazardous material user interface element, a social media feed user interface element, a nearest cameras user interface element, or a nearest hydrants user interface element.

In embodiments, the hazardous material user interface element is selectable, and the memory stores further instructions that, when executed by the processor, cause the system to, in response to the hazardous material user interface element being selected, cause the user interface to display information regarding at least one of a type of hazardous material present at or near the geographical address, or a procedure for handling the type of hazardous material present at or near the geographical address.

In embodiments, the user interface includes a plurality of data source-specific information sections, including at least one of a fire department section that provides information obtained from a fire department data source, a property assessor section that provides information obtained from a property assessor data source, a building department section that provides information obtained from a building department data source, a weather section that provides information obtained from a weather data source, a fire prevention section, a community section, or a government agency section.

In embodiments, each of the plurality of data source-specific information sections is selectable, and the memory stores further instructions that, when executed by the processor, cause the system to, in response to one of the plurality of data source specific information sections being selected, cause the one of the plurality of data source specific information sections to toggle between an expanded state and a collapsed state.

In embodiments, the user interface further includes a plurality of alert icons, each alert icon being selectable and providing an alert corresponding to a structure located at the geographical address. The memory may store further instructions that, when executed by the processor, cause the system to, in response to one of the plurality of alert icons being selected, cause the user interface to be scrolled to display one of the data source specific information sections that corresponds to the selected one of the plurality of alert icons.

In embodiments, the memory stores further instructions that, when executed by the processor, cause the system to obtain, from a dispatch system over a dispatch network, emergency call information regarding an emergency call placed regarding the geographical address, and, in response to the obtaining of the emergency call information, cause the system to commence at least one of obtaining of the data related to the geographical address, the normalizing of the obtained data, the processing of the normalized data, or the generating of the user interface.

In embodiments, the plurality of data sources includes at least one of a building department data source, an Internet platform data source, a utility company data source, a water department data source, a fire department data source, a municipal data source, a pre-plan records management system data source, an inspection records management system data source, a computer aided dispatch data source, an Internet of Things-based data source, a fire prevention based data source, a community data source, or a government agency data source.

In embodiments, the user interface includes a textual description of a structure located at the geographical address, a plurality of alert icons, each alert icon providing an alert corresponding to a structure located at the geographical address, and a plurality of data source specific information sections.

According to another aspect of the present disclosure, a computer-implemented method for providing information to first responders during an emergency response is described. The method includes obtaining, from a plurality of data sources over a communication network, data related to a geographical address. The obtained data is normalized based on a normalization rule. The normalized data is processed, including to identify, based on at least one of a predetermined criterion or the normalized data, a user interface element to include in a user interface. Based on a result of the processing, the user interface including the user interface element is generated and displayed by way of the display device.

According to another aspect of the present disclosure, a non-transitory computer-readable medium is described. The computer-readable medium has stored thereon instructions that, when executed by a processor, cause the processor to implement a method for providing information to first responders during an emergency response. The method includes obtaining, from a plurality of data sources over a communication network, data related to a geographical address. The obtained data is normalized based on a normalization rule. The normalized data is processed, including to identify, based on at least one of a predetermined criterion or the normalized data, a user interface element to include in a user interface. Based on a result of the processing, the user interface including the user interface element is generated and displayed by way of the display device.

### BRIEF DESCRIPTION OF THE DRAWINGS

Various aspects and features of the present information systems are described herein below with references to the drawings, wherein:

FIG. 1 is a schematic block diagram of an illustrative embodiment of a system for providing information to first responders, in accordance with the present disclosure;

FIG. 2 is a schematic block diagram showing additional aspects of the system of FIG. 1, in accordance with the present disclosure;

FIG. 3 is a schematic block diagram of an illustrative embodiment of a computing device that may be employed in various embodiments of the present information system, for instance, as part of the system of FIG. 1;

FIG. 4A and FIG. 4B (collectively, FIG. 4) show process flow diagrams that illustrate an illustrative embodiment of a procedure for providing information to first responders, in accordance with the present disclosure;

FIG. 5 shows an illustrative embodiment of a user interface for providing information to first responders, in accordance with the present disclosure;

FIG. 6 shows an example of a user interface for providing information to first responders, including a birds-eye view of a property, in accordance with the present disclosure;

FIG. 7 shows an example of a user interface for providing information to first responders, including aerial view of a property and including locations of water sources, in accordance with the present disclosure;

FIG. 8 illustrates example alert icons that may be included in a user interface for providing information to first responders, in accordance with the present disclosure;

FIG. 9 shows an example of a user interface for providing information to first responders, including a floor plan sketch of a property, in accordance with the present disclosure;

FIG. 10 shows an example of a user interface for providing information to first responders, including a street view of a property, in accordance with the present disclosure;

FIG. 11 shows an example of a user interface for providing information to first responders, including data obtained from a building department data source, in accordance with the present disclosure;

FIG. 12 shows an example of a user interface for providing information to first responders, including data obtained from a fire department data source, in accordance with the present disclosure;

FIG. 13 shows another example of a user interface for providing information to first responders, including additional data obtained from a fire department data source, in accordance with the present disclosure;

FIG. 14 shows an example of a user interface for providing information to first responders, including data relating to hazardous material located at or near the property, in accordance with the present disclosure;

FIG. 15 shows an example of a user interface for providing information to first responders, including additional data relating to hazardous material located at or near the property, in accordance with the present disclosure;

FIG. 16 shows an example of a user interface for providing information to first responders via a large format display device, such as a computer monitor display, in accordance with the present disclosure;

FIG. 17 shows another example of the user interface of FIG. 16 including a live video stream of the property and social media feed associated with the property, in accordance with the present disclosure;

FIG. 18 shows an example of a user interface for providing information to first responders via a small format display device, such as a mobile communication device, in accordance with the present disclosure;

FIG. 19 shows another view of the user interface of FIG. 18, scrolled to providing additional information to first responders via the small format display device, in accordance with the present disclosure;

FIG. 20 shows an example of a user interface for providing information to first responders for responding to an emergency at an intersection of roads, in accordance with the present disclosure;

FIG. 21 shows an example of a user interface for configuring information to be provided to first responders, in accordance with the present disclosure; and

FIG. 22 shows another example of a user interface for configuring information to be provided to first responders, in accordance with the present disclosure.

### DETAILED DESCRIPTION

The present disclosure is directed to systems, methods, and computer-readable media for providing information to first responders during an emergency response. In general, the systems, methods, and computer-readable media of the present disclosure provide a platform by which first responders are given access to up-to-date, complete, and effective information that they may find relevant to an emergency response. The information is automatically collected in an efficient manner prior to and/or during the emergency response, and is presented in a consumable manner that enables first responders to quickly absorb the relevant information and take appropriate action as necessary in circumstances where mere seconds can often mean the difference between life and death.

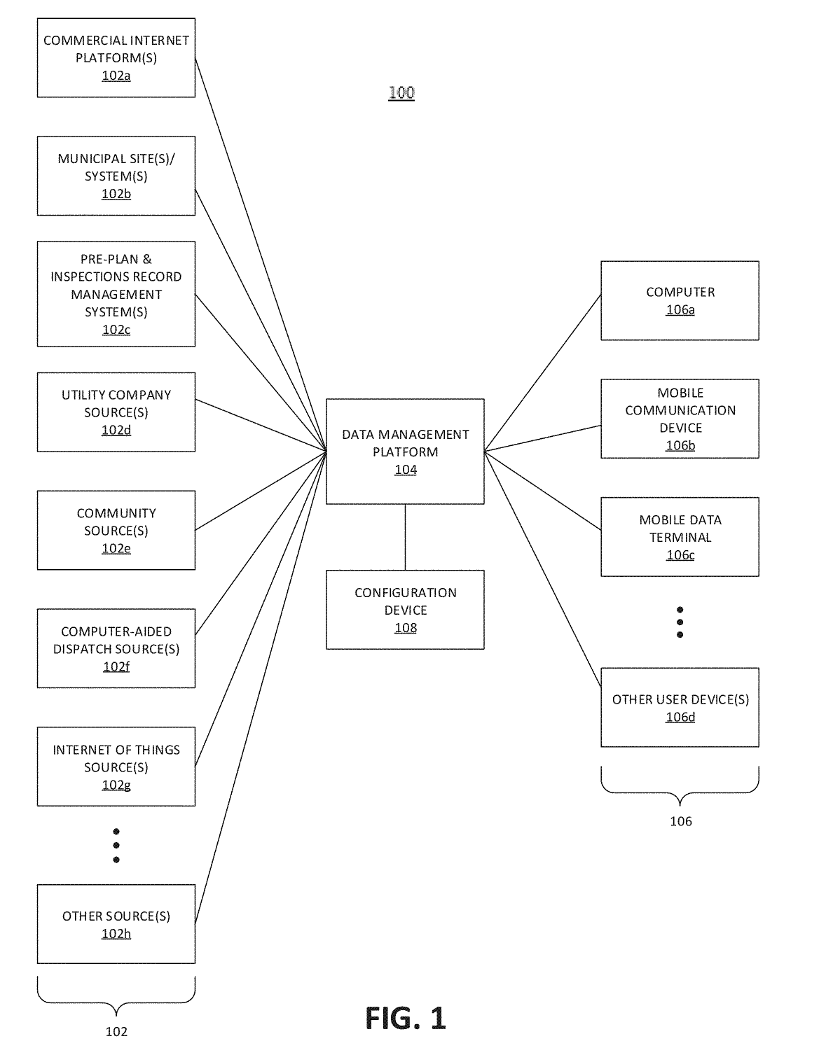

Reference is now made to FIG. 1, which is a schematic block diagram of an illustrative embodiment of a system 100 for providing information to first responders, for example, during an emergency response, in accordance with the present disclosure. The system 100 includes data sources 102a through 102h (collectively, 102), a data management platform 104, user devices 106a through 106d (collectively 106), and a configuration device 108. Each of the data sources 102a through 102h, user devices 106a through 106d, and the configuration device 108 is communicatively coupled to the data management platform 104 by way of one or more communication paths, which, in some examples, include one or more wired and/or wireless communication networks, such as the Internet. The particular number, type, and arrangement of components shown in the system 100 of FIG. 1 (for instance, the particular data sources 102a through 102h and/or the particular user devices 106a through 106d) are provided as examples, but other numbers, types, and arrangements of the components of the system 100 are also contemplated.

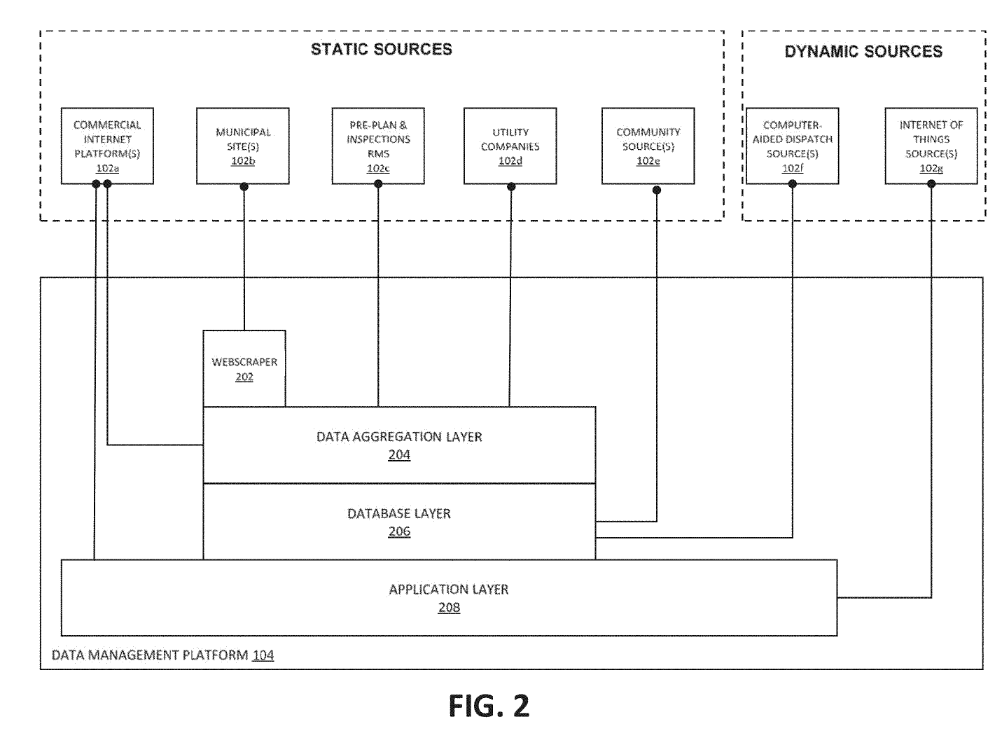

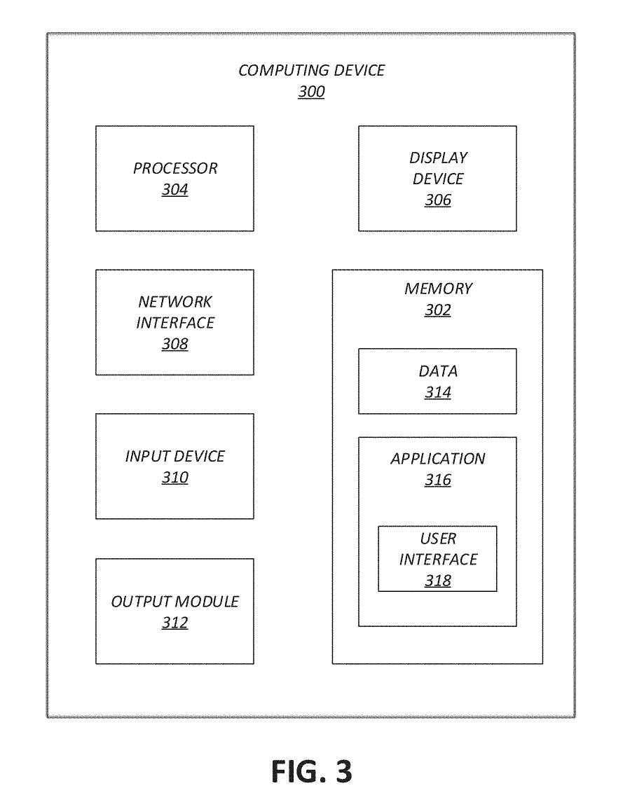

The data management platform 104, in various embodiments, is implemented by hardware components, software components, or a combination of hardware components and software components, as described in further detail below, for instance, in connection with FIG. 2 and FIG. 3. In some embodiments, the data management platform 104 is implemented as a cloud-based distributed array of computing devices, such as servers, that are configured to cooperate with one another to perform the various types of functionality described herein. In other examples, the data management platform 104 is implemented as a single centralized computing device. In general, the data management platform 104 is configured to aggregate data from the various sources 102, process the aggregated data according to one or more rules and/or algorithms, and provide relevant information to first responders by way of quickly comprehensible user interfaces that are displayed via the user devices 106.

The data management platform 104 is configured to obtain and aggregate a variety of types of data from a variety of data sources 102, thereby enabling first responders to be provided with the most up-to-date, complete, relevant, useful, and actionable information possible, enabling first responders to take appropriate action and minimize and/or avoid altogether injuries or deaths when responding to an emergency at a particular location. Because emergency responses are location-based, much of the information that the data management platform 104 obtains and aggregates also is location-based. For example, some of the information that the data management platform 104 obtains corresponds to one or more geographical areas, such as a particular geographically-defined municipality or fire department district, or even a particular commercial or residential address. The data management platform 104, in obtaining and aggregating data from the sources 102, associates each item of data, where possible, with one or more location indicators, such as a residential or commercial address, a geographically-defined region, and/or the like, to enable the aggregated data to be disseminated to the appropriate first responders during an emergency response at a particular location. In some embodiments, the connections between the data sources 102 and the data management platform 104 are continuously maintained and the data is periodically and rapidly aggregated, such that, as information changes in the sources 102, the information is pushed to the data management platform 104 for processing and, if warranted, for display via the user devices 106. In this manner, the data management platform 104 can be ensured to contain up-to-date information.

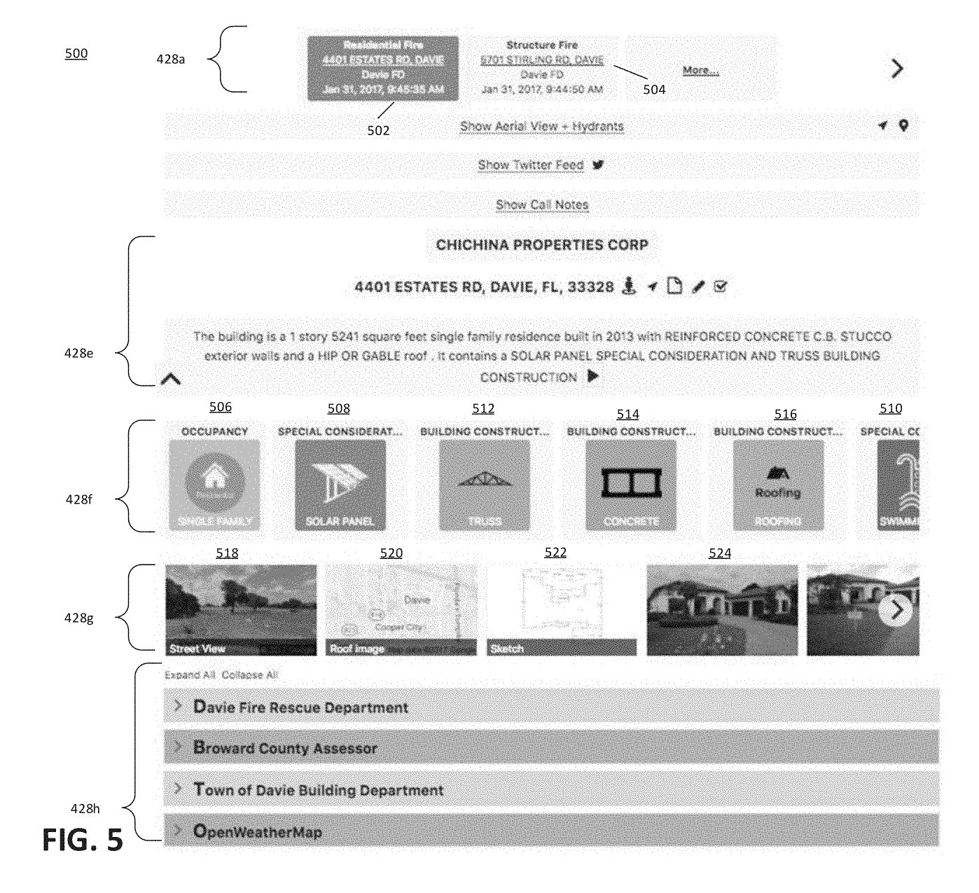

The user devices 106 include one or more computer(s) 106a, mobile communication device(s) 106b, such as a smartphone, mobile data terminal(s) 106c, and/or other types of user devices 106d. In general, the user devices 106 are configured to provide one or more user interfaces (such as, for example, the various user interfaces described below in connection with FIGS. 5 through 22) with which a user (for example, a first responder) may interact to access information that is relevant to an emergency response and that is provided by the data management platform 104 based on data obtained from the sources 102. In some embodiments, the data management platform 104 is configured to determine one or more characteristics of a particular user device 106, such as a screen size of the user device 106, and then provide user interfaces to be displayed via the user devices 106 in a format that is supported by the user device 106, thereby ensuring proper display of information to the user.

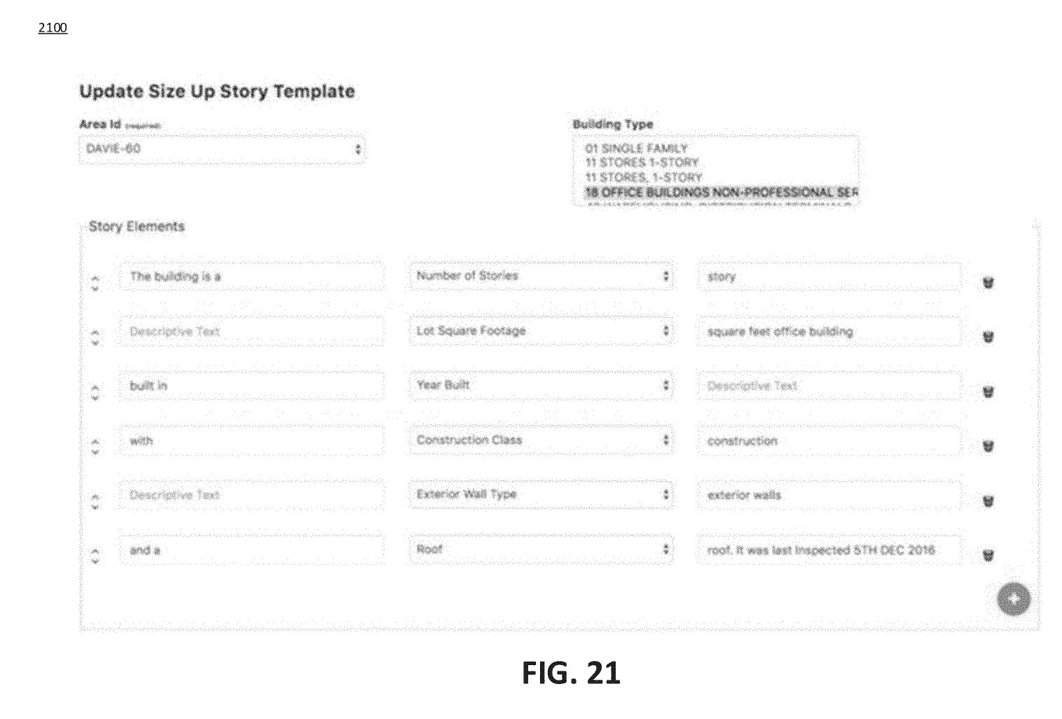

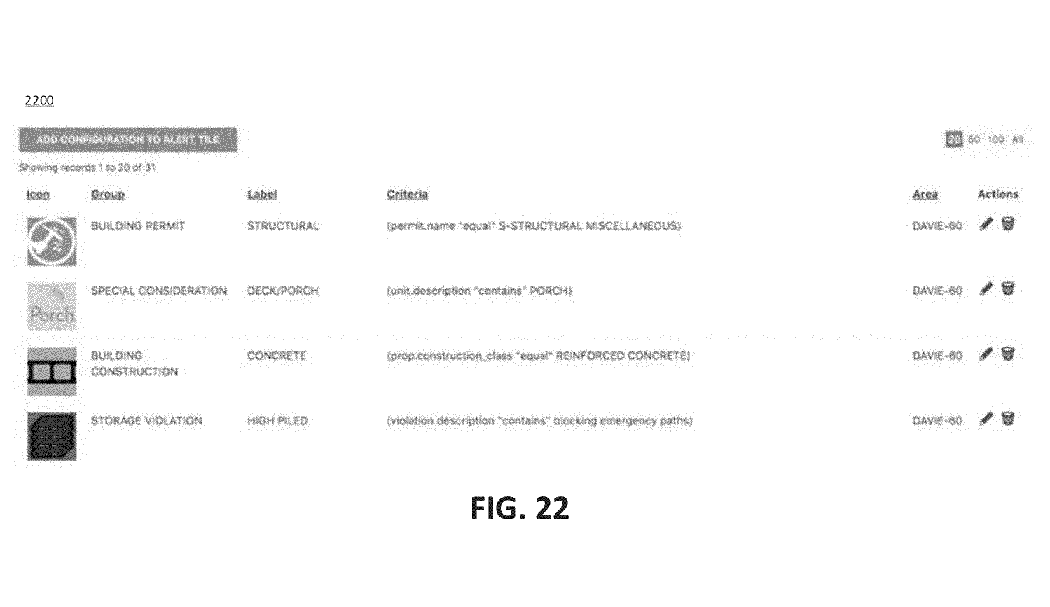

The configuration device 108, in some examples, is a general purpose computer that enables a system administrator to logon to a system administrator account, for example, an account corresponding to a particular municipality, and configure, by way of one or more user interfaces (such as the example user interfaces 2100 and 2200 described below in connection with FIG. 21 and FIG. 22, respectively), various aspects of the functionality of the data management platform 104. Additional aspects of how the configuration device 108 may operate in various embodiments are described below in connection with FIGS. 21 and 22.

The data sources 102 include one or more commercial internet platform data source(s) 102a, municipal site or system data source(s) 102b, pre-plan or inspections record management systems (RMS) data source(s) 102c, utility company data source(s) 102d, community data source(s) 102e, computer-aided dispatch (CAD) data source(s) 102f, Internet of Things (IoT) data source(s) 102g, and/or other types of data sources 102h. In some examples, the data management platform 104 is configured to interface and communicate with the data sources 102 by utilizing one or more pre-determined messaging formats and/or communication protocols, based upon the particular messaging formats and/or communication protocols that each of the data sources 102 is configured to employ. For example, the data management platform 104 utilizes an open source framework, such as the SCRAPY framework as described below, to scrape and automatically download data from websites. The data management platform 104 also obtains data from other systems by employing automated pushes via structured query language (SQL) queries and/or reporting features into secure file transfer protocol (SFTP) or directly into a SCRAPY Framework. Example types of file formats that may be employed for data pushes include, without limitation, .API, .TXT, .CSV, .JSON, .XML, .DBF, shape files, such as .SHP, .GPX, .KML, details from dispatch, such as email files, text Message files, page files, and/or the like.

The data management platform 104 is configured to obtain, from the commercial internet platform data source(s) 102a, data that is made available online by commercial software and/or data companies for personal and/or business consumption. In particular, Table 1 illustrates exemplary types of commercial internet platform data sources 102a and types of data that the data management platform 104 may be configured to obtain from those commercial internet platform data sources 102a.

TABLE 1

| Type of Commercial Internet | |
|---|---|
| Platform Data Source 102a | Type of Data |
| Search Engines | Street View |
| (e.g., GOOGLE, BING, ESRI) | Roof Image |
| | 360° Birds Eye View |
| | Mapping |
| | Address Geocoding |
| | Places/Businesses |
| | Contact Information |
| | Public Layers |
| OpenWeather | Weather Conditions |
| | Wind Speed |
| Social Media Sites | TWITTER Tweets |
| | FACEBOOK Posts |
| | INSTAGRAM Posts |
| Navigation Platforms | Turn-by-Turn directions |
| | Street Conditions |
| Real Estate/Property Sites | Property Information |
| (e.g., ZILLOW) | Photos |
| | Sketches |
| | Owner Information |

The data management platform 104 is configured to obtain, from the municipal site or system data source(s) 102b, data that is gathered by a municipality and either (a) made available online accessible via a website or open data platform, such as SOCRATA or OPENDATASOFT, or (b) made available offline in a digital format residing in a building management system or municipal software suite, such as ACCELLA, MUNICITY, and/or the like. In particular, Table 2 illustrates exemplary types of municipal site or system data sources 102b and types of data that the data management platform 104 may be configured to obtain from those municipal site or system data sources 102b.

TABLE 2

| Type of Municipal Site or | |
|---|---|
| System Data Source 102b | Type of Data |
| County Assessor | Property Information |
| | Additions/Units |
| | Photos & Sketches |
| | Contact Information |
| Building Department | Permits |
| | Inspections |
| | Complaints/Violation |
| | Building Footprints |
| Code Enforcement | Permits |
| | Inspections |
| | Complaints Violations |
| Hazardous Materials | Hazardous Material Type |
| Repositories | Hazardous Material Quantity |
| | Hazardous Material Location |
| GISs | Cameras |
| (Geographical | Previous and Current Incidents |
| Information Systems) | Bridges |
| | Fire Suppression Systems |
| | Natural Water Sources |
| | Roadworks |
| | Facility Types (e.g., elder care facilities) |
| | Hydrants |
| | Other GIS Layers |
| Departments of Transportation | Traffic Cameras |
| | Street Conditions and Incidents |
| Other Agency Sites | Age Care/Health Facility Data |
| | Inspection Data |
| | Camera Footage, CCTV |

The data management platform 104 is configured to obtain, from the pre-plan or inspections RMS data source(s) 102c, data that is collected by fire departments or fire prevention teams and stored within standalone records management systems (RMSs), RMSs within a CAD system, and/or on digital files, such as PDF documents or spreadsheets, stored on a server. In particular, Table 3 illustrates exemplary types of pre-plan or inspections RMS data sources 102c and types of data that the data management platform 104 may be configured to obtain from those pre-plan or inspections RMS data sources 102c.

TABLE 3

| Type of Pre-plan or Inspections | |
|---|---|
| RMS Data Source 102c | Type of Data |
| Fire Department Pre-Plan | Occupancy Data |
| | Construction Data |
| | Property Data |
| | Hazards |
| | Sketches/Drawing |
| | Utilities Details |
| | Fire System/Suppression Details |
| Fire Prevention | Permits |
| (similar to code enforcements) | Tests/Inspections |
| | Complaints/Violations |
| | Hazardous Materials |
| | Contact Information |

The data management platform 104 is configured to obtain, from the utility company data source(s) 102d, data that is provided, generally offline, by organizations that provide utility services, such as water companies, electric companies, gas companies, and/or the like. In particular, Table 4 illustrates exemplary types of utility company data sources 102d and types of data that the data management platform 104 may be configured to obtain from those utility company data sources 102d.

TABLE 4

| Type of Utility Company | |
|---|---|
| Data Source 102d | Type of Data |
| Gas | Gas Units |
| | Gas Shut-off |
| | Gas Main lines |
| Electric | Electric Units |
| | Electric Shut-off |
| | Electricity Lines |
| | Pole Locations |
| Water | Water Units |
| | Water Shut-off |
| | Water Main Lines |
| | Heating Units |
| | Solar Panels |

The data management platform 104 is configured to obtain, from the community data source(s) 102e, data that is provided directly from residents and/or commercial property owners through online forms and uploaded to the data management platform 104 via a front-end component (not shown in FIG. 2). In particular, Table 5 illustrates exemplary types of community data sources 102e and types of data that the data management platform 104 may be configured to obtain from those community data sources 102e.

TABLE 5

| Type of Community Data Source 102e | Type of Data |
|---|---|
| Residential Property Owners | Contact Information |
| | Potential Hazards |
| | Occupancy Considerations |
| | Construction Information |
| | Spare Key Location |
| Commercial Property Owners | Contact Information |
| | Business Information |
| | Hazardous Materials |
| | Occupancy Considerations |
| | Construction Information |
| | Knox Box location |
| | Fire Alarm Control Panel Code |

The data management platform 104 is configured to obtain, from the CAD data source(s) 102f, various types of data provided throughout the course of an emergency response, for example, beginning with a geographical address and/or other details regarding an emergency call that is placed to a fire department. In particular, Table 6 illustrates exemplary types of data that the data management platform 104 may be configured to obtain from a CAD data source 102f.

TABLE 6
Type of Data

Address for Emergency Response
Incident Type
Incident Details/Notes
Units Responding
Details of device where data management
platform 104 is accessed (e.g., unit number,
permission, active calls)
Details of Prior Incident(s)
Address List
Occupancy Data (e.g., from RMS)
Hazard Data (e.g., from RMS)

The data management platform 104 is configured to obtain, from the IoT data source(s) 102g, data that is provided, often real-time and dynamic, from devices that are connected to the Internet or another type of communication network and that have the ability to share data based on logic algorithms. In particular, Table 7 illustrates exemplary types of IoT data sources 102g and types of data that the data management platform 104 may be configured to obtain from those IoT data sources 102g.

TABLE 7

| Type of IoT Data Source 102g | Type of Data |
|---|---|
| Smart Homes | Property Information |
| | Fire-related Information |
| | Security-related Information |
| | Live Footage |
| Drones | Mapping |
| | Live Scene Footage |
| Smart Personal Protective Equipment | Responder Vitals |
| | Live Scene Footage |
| | Hazardous Material Readings |

Referring now to FIG. 2, in various embodiments some of the data sources 102 (for example, data sources 102a through 102e) may be static data sources in that the data contained therein is not expected to change during the course of an emergency response. Other ones of the data sources 102 (for example, data sources 102f and 102g) may be dynamic data sources in that the data contained therein may be expected to change during the course of an emergency response. In some embodiments, the data management platform 104 is configured to utilize different modules and/or techniques to obtain data from the various data sources 102 based on a variety of factors. For example, the data management platform 104 may be configured to obtain data from the static data sources 102a through 102e prior to the occurrence of an emergency response and may be configured to obtain data from the dynamic data sources 102f and 102g periodically throughout the course of the emergency response, thereby avoiding the need to obtain large amounts of data from the static data sources 102a through 102e at the outset of the emergency response, all the while ensuring that first responders are provided with the most recently available information from the dynamic data sources 102f and 102g during the emergency response.

As shown in FIG. 2, in some examples, the data management platform 104 includes a webscraper module 202, a data aggregation layer 204, a database layer 206, and an application layer 208 that cooperate to implement various functions of the data management platform 104. In particular, depending upon characteristics of the data sources 102, the webscraper module 202, data aggregation layer 204, database layer 206, and application layer 208 may be communicatively coupled to certain ones of the data sources 102 to properly interface with the data sources 102 and enable optimal aggregation of data. For example, the webscraper module 202 may be coupled to, and configured to obtain data from, the municipal site or system data source(s) 102b; the data aggregation layer 204 may be coupled to, and configured to obtain data from, the commercial internet platform data source(s) 102a, the pre-plan or inspections RMS data source(s) 102c, and/or the utility company data source(s) 102d; the database layer 206 may be coupled to, and configured to obtain data from, the community data source(s) 102e and/or the CAD data source(s) 102f; and the application layer 208 may be coupled to, and configured to obtain data from, the IoT data source(s) 102g.

The webscraper module 202, in some examples, includes web-crawling software, such as a collection of scrapers, built upon the SCRAPY.ORG platform to scrape municipal and related sites and parse obtained data and provide the parsed data to the database layer 206. Each scraper of the collection of scrapers, in some instances, may run automatically after an initial pull to search for updates in data based on date of entry of the data. The database layer 206 is automatically checked and validated at both a macro level (e.g., to determine whether the scraper has been executed) and a micro level (e.g., to determine whether there are any inconsistencies between data in the sources 102 and data in the database layer 206).

The data aggregation layer 204, in some aspects, includes a data aggregation server (which, may in turn include a collection of servers and databases) that obtains and stores data from various static data sources 102. The data aggregation server automatically connects to and imports data from various data sources 102, such as the commercial internet platform data sources 102a, municipal site or system data source(s) 102b (by way of the webscraper module 202), pre-plan or inspections RMS data sources 102c, and utility company data sources 102d. The connection and import is performed, in some embodiments, by utilizing an application programming interface (API), an automated file download, a secure file transfer protocol (FTP) extraction, and/or a direct database view with automated import and export.

In some embodiments, before being stored and/or forwarded for subsequent processing, data obtained by the data aggregation layer 204 is normalized into a common model, having predetermined data fields, such as the example model shown in Table 8.

TABLE 8
Data Fields of Common Model

Places
Property
Permits
Tests/Inspections
Complaints/Violations
Contact Information
Hazardous Materials
Units

The data aggregation layer 204 automatically imports, normalizes, and correlates data and also identifies possible correlation issues or data anomalies and presents details and statistics for manual review by a data analyst when warranted. By virtue of this automation feature, new accounts or jurisdictions can be quickly added to the data management platform 104 and its data is kept up-to-date. Data is imported automatically from various forms in a variety of manners and then is periodically checked for incremental changes for additional imports. For example, depending on the data source 102, data may be available as comma separated value (CSV) files, online data that requires web crawling and scraping, or from application programming interfaces (APIs) accessing remote databases.

The data aggregation layer 204 obtains data in various formats and standardizes the data into its core tables for correlation, which also facilitates data sharing between accounts or jurisdictions for a variety of purposes, such as mutual aid purposes. The data aggregation layer 204 also gathers data and normalizes the data into its core tables to facilitate the presentation of key information in an intuitive format. In some embodiments, the data aggregation layer 204 ensures its data remains up-to-date by periodically scanning data sources for updates and only importing changes (e.g., a delta). For example, the data aggregation layer 204 uses data fingerprinting to efficiently detect data changes and only import new incremental data, thereby reducing the volume of data transfer and facilitating scaling of data aggregation.

Data obtained by the data aggregation layer 204 is validated based on proprietary and/or third party validation tools. In some embodiments, the validation is focused on utilizing parcel key, address, and/or latitude/longitude to ensure that the data obtained from the numerous data sources 102 is associated with the correct building. For example, for each item of data obtained by the data aggregation layer 204 that includes address information, such as GIS address points, the data aggregation layer 204 extracts key components of the GIS address points, such as the address, the parcel, and latitude and longitude information for the addresses, and normalizes the components into a standardized format to facilitate their correlation with data obtained from other data sources. Validation routines are automatically executed upon importing and/or refreshing of the data by the data aggregation layer 204. As exceptions are detected during the validation process, they are identified and programmatically and/or systematically corrected, in which case, the correction becomes a part of the validation routine in future validation processing.

In some embodiments, data obtained by the data aggregation layer 204 is normalized and/or validated in a different manner for each data source. For example, assessor improvement data may be converted to a specific unit type. General records that cover permit, inspection, violations and/or the like are populated, according to their type or category, into tables, for instance, tables such as Table 9 described below that the data management platform 104 stores and uses on a case-by-case basis to determine which, if any, alert icons are to be displayed via the user interface 500 for a particular emergency. In other examples, only portions of data (for instance, columns) that fit within the model are imported into the table. For example, one permit may have thirty columns worth of data, but only permit type, date issued, expiration date, description, permit number, and associated parcel/address are imported into the table and utilized for matching. In another aspect, the normalization includes indexing or formatting, for instance, including converting textual numbers to numerical numbers. In some examples, the data management platform 104 stores and uses predetermined code tables to convert codes (e.g., property code: R1) to descriptive text (e.g., single family residential).

The database layer 206, in various embodiments, includes one or more cloud-based databases in which data aggregated from the sources 102 is stored and from which the data is transmitted via a communications network, such as the Internet, to the user devices 106 for access by first responders. The database layer 206 automatically, and periodically at an automated rate, pulls validated and translated data from the data aggregation layer 204, or, more particularly, the data aggregation server thereof, in some embodiments. The data is continuously validated based on rules refined during an onboarding process of an account (e.g., an account of a particular fire department or other municipality). In some embodiments, over time, the set of rules serves as a basis for machine-learning-based data validation and/or artificial intelligence-based data validation. The database layer 206 also provides a foundation upon which the application layer 208 performs its functions, such as translating data and generating user interfaces by which the data is displayed.

The application layer 208 translates data that it receives from the various data sources 102 (in some instances, by way of one or more of the webscraper module 202, the data aggregation layer 204, and/or the database layer 206) into a consumable format and generates user interfaces by which the data is presented to first responders via the user devices 106. The application layer 208 also manages user interactions with the user interfaces by way of the user devices 106, for instance, to cause different items of data to be presented to the user in response to a particular user input command. Additional functionality of the data management platform 104, and/or the webscraper module 202, data aggregation layer 204, database layer 206, and/or application layer 208 thereof, is described below in further detail.

FIG. 3 is a schematic block diagram of a computing device 300 that may be employed in accordance with various embodiments herein. Although not explicitly shown in FIG. 1 or FIG. 2, in some embodiments, the computing device 300, or one or more of the components thereof, are included in, and/or employed within, one or more components of the system 100, such as, for example, the data management platform 104, the configuration device 108, one or more of the data sources 102 or user devices 106, and/or one or more of the webscraper module 202, the data aggregation layer 204, the database layer 206, or the application layer 208. In this regard, the computing device 300, or one or more of the components thereof, may further represent one or more components of the system 100, such as, for example, the data management platform 104, the webscraper module 202, the data aggregation layer 204, the database layer 206, the application layer 208, and/or the configuration device 108.

The computing device 300 may, in various embodiments, include one or more memories 302, processors 304, display devices 306, network interfaces 308, input devices 310, and/or output modules 312. The memory 302 includes non-transitory computer-readable storage media for storing data and/or software that is executable by the processor 304 and which controls the operation of the computing device 300. In embodiments, the memory 302 may include one or more solid-state storage devices such as flash memory chips. Alternatively, or in addition to the one or more solid-state storage devices, the memory 302 may include one or more mass storage devices connected to the processor 304 through a mass storage controller (not shown in FIG. 3) and a communications bus (not shown in FIG. 3). Although the description of computer-readable media contained herein refers to a solid-state storage, it should be appreciated by those skilled in the art that computer-readable storage media can be any available media that can be accessed by the processor 304. That is, computer readable storage media includes non-transitory, volatile and non-volatile, removable and non-removable media implemented in any method or technology for storage of information such as computer-readable instructions, data structures, program modules or other data. Examples of computer-readable storage media include RAM, ROM, EPROM, EEPROM, flash memory or other solid state memory technology, CD-ROM, DVD, Blu-Ray or other optical storage, magnetic cassettes, magnetic tape, magnetic disk storage or other magnetic storage devices, or any other medium which can be used to store the desired information and which can be accessed by computing device 300.

In some embodiments, the memory 302 stores data 314 and/or an application 316. In some aspects the application 316 includes a user interface component 318 that, when executed by the processor 304, causes the display device 306 to present a user interface (not shown in FIG. 3), such as one or more of the user interfaces 2100 or 2200 (FIG. 21 or FIG. 22) that may be provided by way of one or more display devices (not shown in FIG. 1) that may form a part of the user devices 106 and/or the configuration device 108 (FIG. 1). The network interface 308, in some embodiments, is configured to couple the computing device 300 and/or individual components thereof to a network, such as a wired network, a wireless network, a local area network (LAN), a wide area network (WAN), a wireless mobile network, a Bluetooth network, the Internet, and/or another type of network. The input device 310 may be any device by means of which a user may interact with the computing device 300. Examples of the input device 310 include without limitation a mouse, a keyboard, a touch screen, a voice interface, and/or the like. The output module 312 may, in various embodiments, include any connectivity port or bus, such as, for example, a parallel port, a serial port, a universal serial bus (USB), or any other similar connectivity port known to those skilled in the art.

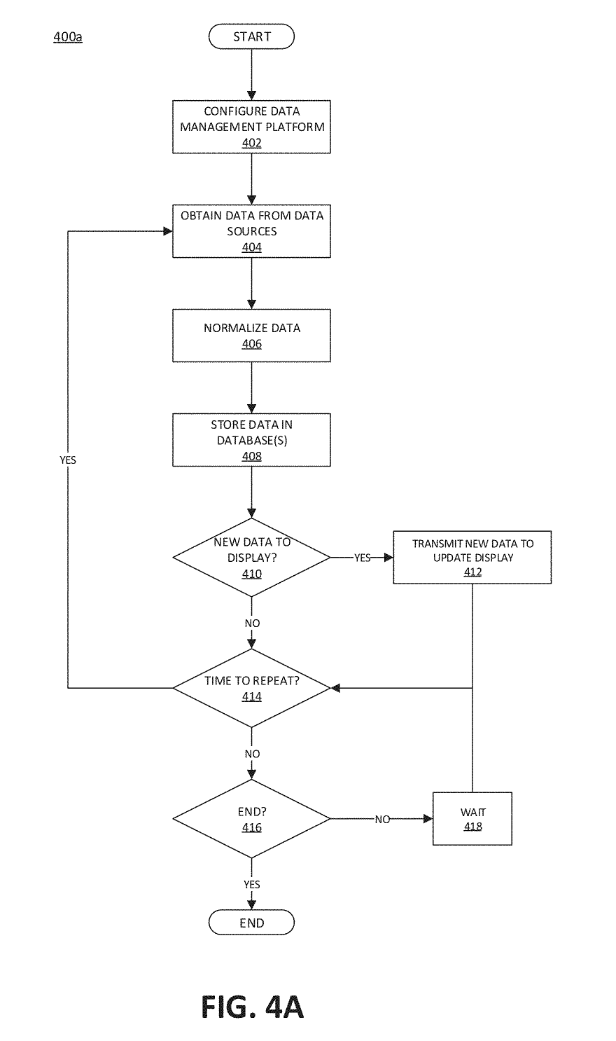

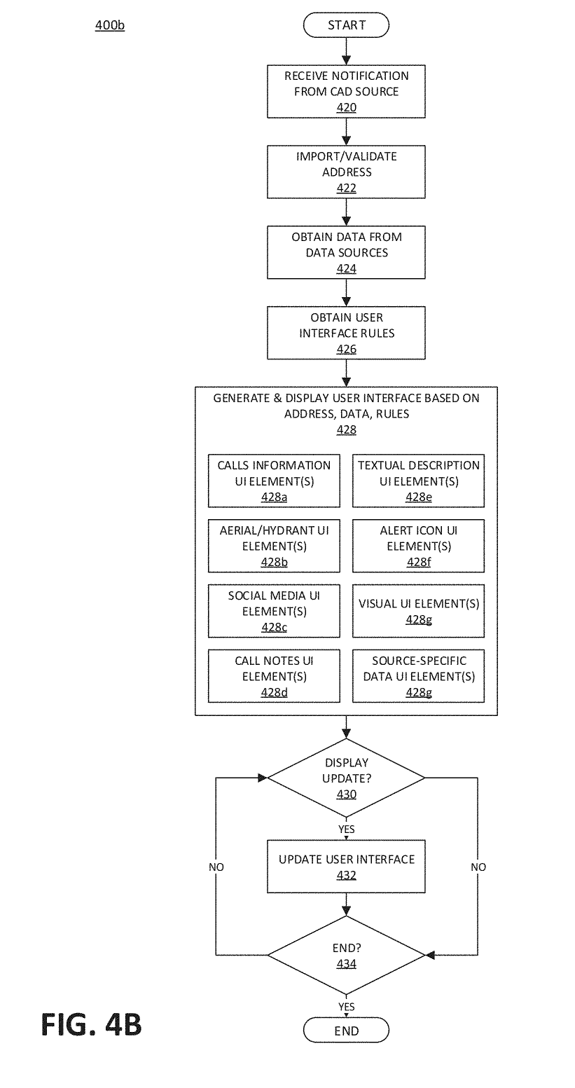

Having described aspects of illustrative system 100 in the context of FIG. 1, FIG. 2, and FIG. 3, reference is made to FIG. 4A and FIG. 4B (collectively FIG. 4) to describe exemplary procedures 400a and 400b (collectively, 400) for providing information to first responders by way of the system 100. In general, the procedure 400a includes configuring the data management platform 104 (for example, as part of an onboarding process for a particular account, such as an account of a particular fire department) and then executing a continuous aggregation loop in which the data management platform 104 continuously, or at a particular repetition rate, obtains and aggregates from the various data sources 102 data to be displayed to first responders via the user devices 106 in the event of an emergency. The procedure 400b illustrates the functionality of the system 100 once an emergency response has commenced, for instance, in response to the placement of an emergency call to the fire department. In various embodiments, the procedures 400a and 400b may be executed concurrently with respect to one another, and certain steps of one of the procedures 400a and 400b may be dependent upon, or otherwise involve interaction with, steps of the other one of the procedures 400a and 400b.

Referring initially to FIG. 4A, at block 402 the data management platform 104 is configured by way of the configuration device 108. In general, configuration of the data management platform 104 at block 402 includes data-related configuration and account-related configuration. In various embodiments, data-related configuration may include (1) configuring the webscraper module 202 to scape data from particular data sources specific to an account, jurisdiction, or region, such as by selecting and/or mapping particular types of data fields to be scraped and/or (2) configuring the data aggregation layer 204 to execute address normalization and validation algorithms based on data particular to a specific region. Account-related configuration may include configuring (1) users for an account, (2) roles and permissions of each user for an account, (3) account setup (e.g., to define the primary response geographical area and mutual aid geographical area), (4) user interface page layout for an account (which may be configured through a drag-and-drop page layout configuration tool), (5) alert icons for an account (which may be configured by way of user interface 2200), and/or (6) textual description user interface elements for an account (which may be configured by way of the user interface 2100). Exemplary embodiments of how the configuration at block 402 proceeds are described below in connection with FIG. 21 and FIG. 22.

Once the data management platform 104 has been configured at block 402, at block 404 the data management platform 104 obtains data from the various data sources 102, for example, as described above in connection with FIG. 2. At block 406, for any data that was obtained at block 404 from the various data sources 102 and that requires being normalized into a common model, such as the common model of Table 8, the data management platform 104 normalizes the data into the common model based on one or more normalization rules. In some embodiments, the normalization at block 406 includes extracting data field values from the obtained data, translating the data fields and/or applying the data fields to one or more common models, such as the common model of Table 8.

The data management platform 104 manages the obtaining of data for different clients or accounts located at different geographical locations. The data management platform 104 processes the data it obtains to determine which location(s) the data corresponds to and, accordingly, the account(s) to which the data is relevant. This can be helpful, for instance, in mutual aid scenarios, where the fire departments of multiple jurisdictions are cooperating to respond to a particular emergency across their jurisdictional boundaries. In some embodiments, during importation of data, the data management platform 104 uses scripts to execute a location matching algorithm to map data obtained across multiple data sources 102 with a location(s) and/or an account(s) to which the data is relevant (for instance, by using parcel, address, and/or latitude and longitude coordinate information included in items of data). Any failures outputted by the script may be addressed via an automated cleaning script initiated by an account administrator or via a manual inspection by the account administrator.

At block 408, the data management platform 104 stores, in the database layer 206, the data that was obtained at block 404 and/or normalized at block 406. At block 410, the data management platform 104 determines whether any new data is to be displayed by way of the user devices 106. For example, the data management platform 104 may determine at block 410 whether new data is to be displayed by determining whether any new data has been made available (for instance, where new dynamic data has been received from the data sources 102f and/or 102g). If, during the course of an emergency response the procedure 400b is being used to present data to first responders by way of the user devices 106, and new dynamic data has been received (for instance, from the data sources 102f and/or 102g), then the data management platform 104 determines at block 410 that new data is to be displayed to provide first responders with up-to-date information. If it is determined at block 410 that new data is to be displayed (“YES” at block 410), then at block 412 the new data to be displayed is transmitted to the user devices 106 to be displayed (for example, by way of a newly generated or updated user interface).

If it is determined at block 410 that no new data is to be displayed (“NO” at block 410), then at block 414 the data management platform 104 determines whether it is time to repeat the obtaining and aggregation of data at block 404, for instance, to obtain more recent data to ensure that the database layer 206 contains the most up-to-date and complete information possible. In some embodiments, the determination at block 410 may be based on a minimum predetermined wait period that is required to elapse between repetitions of the functionality of block 404. If it is determined at block 414 that it is time to repeat the obtaining of data (“YES” at block 414), then the procedure 400a progresses back to block 404 to obtain and aggregate additional data from the various data sources 102. If it is determined at block 414 that it is not yet time to repeat the obtaining of data (“NO” at block 414), then at block 416 the data management platform 104 determines whether the procedure 400a is to be terminated, for instance, in a case where an account is being disabled or reconfigured. If it is determined at block 416 that the procedure 400a is to be terminated (“YES” at block 416), then the procedure 400a is terminated. If it is determined at block 416 that the procedure 400a is not to be terminated (“NO” at block 416), then at block 418 the procedure 400a waits for a predetermined time period and then progresses back to block 414 to determine whether it is time to repeat the obtaining and aggregation of data at block 404, as described above.

Referring now to FIG. 4B, the procedure 400b begins at block 420, where the data management platform 104 receives from the CAD data source 102f a notification of an emergency at a particular location. In some embodiments, the notification received at block 420 from the CAD data source 102f is automatically triggered by an emergency telephone call that is placed to a computer-aided dispatch system informing an emergency dispatcher of the emergency. The CAD data source 102f may be configured to provide the notification in real-time to the data management platform 104 in any number of ways, such as by way of a text message, an email message, or any other type of message.

The notification received at block 420 includes a geographical address or other location identifier at which the emergency is occurring and to which the emergency response is to be directed. At block 422, the data management platform 104 imports and validates the address or location identifier within the notification. For example, the data management platform 104 may recognize and/or match the address received from the CAD data source 102f to an address in the places table, such as the places data field of the common model of Table 8, which in some embodiments includes a list of all addresses of jurisdictions covered by the data management platform 104. The data management platform 104 is configured to recognize intersections of roads, address errors, subunits in buildings that have multiple subunits, and utilizes intermediary user interfaces and/or user experiences to ensure the proper address is being utilized for presenting information relevant to the first responders.

At block 424, the data management platform 104 obtains data (such as dynamic data recently made available) from the various data sources 102 and/or retrieves from the database layer 206 data that was previously aggregated according to procedure 400a. At block 426, the data management platform 104 obtains, for example, from the database layer 206, user interface rules that were previously configured (for instance, by way of the configuration device 108 during an onboarding process or afterwards) for an account that corresponds to the particular address, such as a fire department whose jurisdiction includes the address. The user interface rules, in various embodiments, define aspects of the user interfaces to be displayed for first responders associated with that particular account. In this manner, on an account-by-account basis, different accounts (e.g., fire departments) can configure user interfaces to present information they choose to see in the manner they chose to see it. Thus, if one fire department prefers to be presented with a particular type of information, but another fire department prefers not to be presented with that type of information, each fire department can, by way of the data management platform 104, be presented with only the types of information they deem relevant and are interested in seeing.

At block 428, the data management platform 104 generates and displays one or more user interfaces, including one or more user interface elements, based on the address validated at block 422, the data obtained at block 424, and/or the user interface rules that were obtained at block 426. Exemplary types of user interface elements that may be generated and/or displayed at block 428 include, without limitation, call information user interface elements 428a, aerial/hydrant user interface elements 428b, social media user interface elements 428c, call notes user interface elements 428d, textual description user interface elements 428e, alert icon user interface elements 428f, visual user interface elements 428g, and source-specific data user interface elements 428g, which are described in further detail below in connection with FIG. 5 through FIG. 20.

At block 430, the data management platform 104 determines whether any update to the user interfaces displayed at block 428 is warranted. In some embodiments, for example, the determination at block 430 is made based on whether any new data has recently been made available, as indicated at block 412 of procedure 400a. For instance, if new data is available then an update to the user interfaces is deemed warranted, and if no new data is available then no update to the user interfaces is deemed warranted. Additionally, or alternatively, the determination at block 430 is made based on whether any user input command has been received at the data management platform 104 by way of one or more of the user devices 106. For example, if no user input command has been received, then no update to the user interfaces is deemed warranted, and, if a user input command has been received, then a particular update to the user interfaces is deemed warranted based on the type of user input command that was received (for example, a command causing an expandable and collapsible section of the user interface to toggle between an expanded state or a collapsed state, a command causing the user interface to be scrolled from displaying a first portion to displaying a second portion, and the like).

If it is determined at block 430 that an update to the user interfaces displayed at block 428 is warranted (“YES” at block 430), then at block 432 the user interfaces are updated accordingly and displayed via the user devices 106, and the procedure 400b progresses to block 434. If it is determined at block 430 no update to the user interfaces displayed at block 428 is warranted (“NO” at block 430), then the procedure 400b progresses to block 434.

At block 434, the data management platform 104 determines whether the procedure 400b is to be terminated. In some embodiments, the determination at block 434 is based on whether the data management platform 104 has received a command from an authorized administrator by way of one of the user devices 106 indicating that the emergency response is terminated. If it is determined at block 434 that the procedure 400b is to be terminated (“YES” at block 434), then the procedure is terminated. If it is determined at block 434 that the procedure 400b is not to be terminated (“NO” at block 434), then the procedure progresses back to block 430 to determine whether any update to the user interfaces is warranted in the manner described above.

Reference is now made to FIG. 5 through FIG. 20 to describe illustrative aspects of exemplary types of user interface elements that may be generated and/or displayed at block 428. FIG. 5 shows an example user interface 500 that may be generated and displayed at block 420 (FIG. 4B) for providing information to first responders, in accordance with an embodiment of the present disclosure. In some embodiments, the user interface 500 is generated using data from the various data sources 102 by way of the database layer 206, as described in connection with FIG. 4A. The user interface 500 includes a variety of user interface elements, including call information user interface elements 428a, aerial/hydrant user interface element 428b, social media user interface elements 428c, call notes user interface elements 428d, textual description user interface elements 428e, alert icon user interface elements 428f, visual user interface elements 428g, and source-specific data user interface elements 428h. Some of the user interface elements 428a through 428h are selectable via the user device 106 to toggle between an expanded state and a collapsed state. For instance, in the example user interface 500 of FIG. 5, the user interface elements 428b, 428c, 428d, 428h are shown in a collapsed state, and the user interface elements 428f and 428g are selectable to cause additional information to be displayed. In this manner, the user interface 500 enables a first responder to quickly obtain information relevant to an emergency response.

The call information user interface elements 428a includes selectable icons regarding emergency calls received at the local dispatcher. In particular, the call information user interface elements 428a includes an icon 502 that corresponds to the presently selected emergency call, for which further information is being provided below in the user interface 500, as well as an icon 504 for another emergency call. Each of the icons 502 and 504 includes a brief description of the type of emergency call and an address corresponding to the emergency call (for example, the address validated at block 422 as described above).

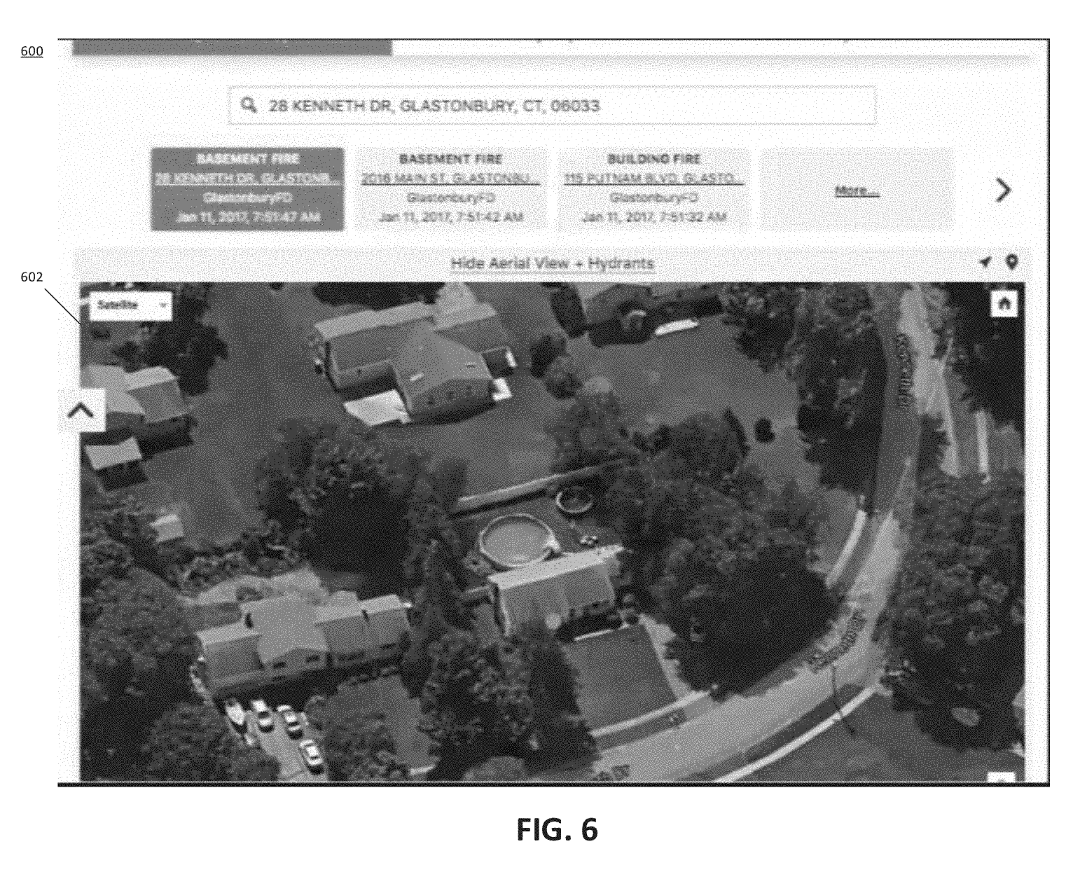

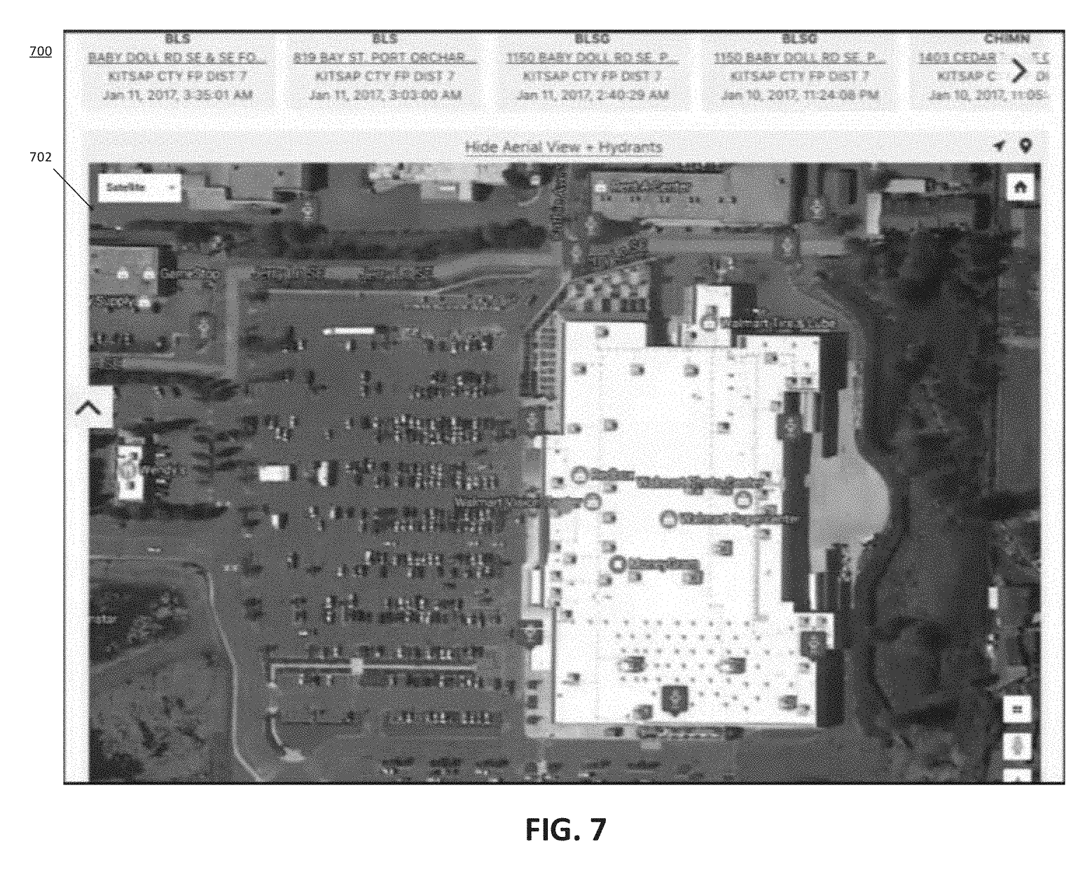

The aerial/hydrant user interface element 428b, although shown in a collapsed state in the user interface 500, is selectable to cause the user interface element 428b to expand into an expanded state showing an aerial view 602 (for example, a previously obtained aerial image) of the address of the emergency response, as shown in the user interface 600 of FIG. 6. In some embodiments, an aerial view 702 of the address of the emergency response also includes an overlay (for example, based on a GIS layer) that indicates locations of fire hydrants in the vicinity, as shown in the user interface 700 of FIG. 7.

The social media user interface elements 428c, although shown in a collapsed state in the user interface 500, is selectable to cause the user interface element 428c to expand into an expanded state showing social media content relating to the address of the emergency response, for example, social media content filtered by geographical location of the sources of the social media content at the time of posting.

The call notes user interface elements 428d, although shown in a collapsed state in the user interface 500, is selectable to cause the user interface element 428d to expand into an expanded state showing notes regarding the emergency response call, such as notes inputted into the CAD data source 102f by a dispatcher and/or notes inputted by first responders by way of the user devices 106.

The textual description user interface elements 428e includes a brief description or size-up of the structure located at the address corresponding to the emergency response call. In some embodiments, the description of the structure is generated based on pre-defined parameters, such as parameters based on the user interface rules 426, which may have been previously configured by way of the configuration device 108. Exemplary types of information that may be included in the brief description of the user interface element 428e include, without limitation, a number of stories of the structure, a square footage of the structure, a date of construction of the structure, a type of construction material of the structure, a date of inspection of the structure, historical building code violations issued for the structure, and the like.

The alert icon user interface elements 428f are icons that each belong to a one of multiple alert icon groups or categories and provide an alert corresponding to the structure located at the address of the emergency response. In some examples, the alert icon user interface elements 428f are color-coded based on the alert icon category to which it corresponds, for ease of reference during emergencies. In embodiments, only the particular individual alert icon user interface elements 428f that are applicable to a structure or address corresponding to the emergency call (for example, the address validated at block 422 as described above) are displayed via the user interface 500, so as to provide first responders with information useful to a particular emergency response and avoid inundating first responders with information that is inapplicable, irrelevant, or useless. If a particular individual alert icon user interface element 428f is not applicable to the structure or address corresponding to the emergency call, then that alert icon user interface element 428f is not displayed via the user interface 500. For instance, if no solar panel is installed on the structure located at the address corresponding to the emergency call, then the alert icon 508 (described below) indicating whether the structure includes a solar panel is not displayed via the user interface 500.

The data management platform 104 determines whether a particular alert icon is applicable to a structure or address corresponding to the emergency call, and thus whether the particular alert icon is to be displayed via the user interface 500, by determining whether data aggregated at block 404 and/or block 424 satisfies one or more corresponding criteria, more particularly, whether aggregated data includes one or more predetermined data field values (e.g., strings of letters, numbers, symbols, and/or the like). The data management platform 104 makes such determinations by way of textual searches of aggregated data. For example, criteria for displaying an alert icon may require that data which was aggregated at block 404 and/or 424 for the particular structure or address corresponding to the emergency call include a particular data field and/or that the particular data field contain a predetermined value. For instance, as illustrated in Table 9 below, an “interior” alert icon may belong to a category “alteration” and may be associated with criteria for determining whether a “permit.name” data field includes a phrase “ALTER INTERIOR.” In this example, if data aggregated at block 404 and/or 424 for the structure or address corresponding to the emergency call includes a “permit.name” data field that includes the phrase “ALTER INTERIOR,” then the “interior” alert icon is deemed applicable to that structure or address and is displayed via the user interface 500.

Each of the criteria is generally formatted as a query that can be executed to compare one or more data fields to one or more textual values using one or more operators (for example, “equals” or “contains”) to generate a query result. Example types of criteria are shown in further detail in Table 9 below. In some embodiments, an account administrator can use a user interface (such as user interface 2200 discussed below) to configure custom criteria to be used by the data management platform 104 based on the types of data sources and/or data fields with which the account administrator expects the data management platform 104 to interface.

A list of categories, alert icons, and corresponding criteria may be stored in memory 302 of the data management platform 104 and accessed on a case-by-case basis to determine which, if any, alert icons are to be displayed via the user interface 500 for a particular emergency. In this manner, the data management platform 104 may be configured to quickly determine, based on data aggregated at block 404 and/or 424, which alert icons, if any, to display via the user interface 500 for a particular emergency, despite the data in some instances being aggregated from disparate sources, in different jurisdictions, and/or in different formats.

In some instances, a particular alert icon may correspond to multiple criteria such that, if any item of data aggregated from any data source corresponding to the structure or address corresponding to the emergency call satisfies any one of the multiple criteria, then the alert icon is deemed applicable and is displayed via the user interface 500. In other instances, a particular alert icon may correspond to multiple criteria such that the alert icon is only deemed applicable and displayed via the user interface 500 if an item of data aggregated from a data source corresponding to the structure or address corresponding to the emergency call satisfies each of the multiple criteria.

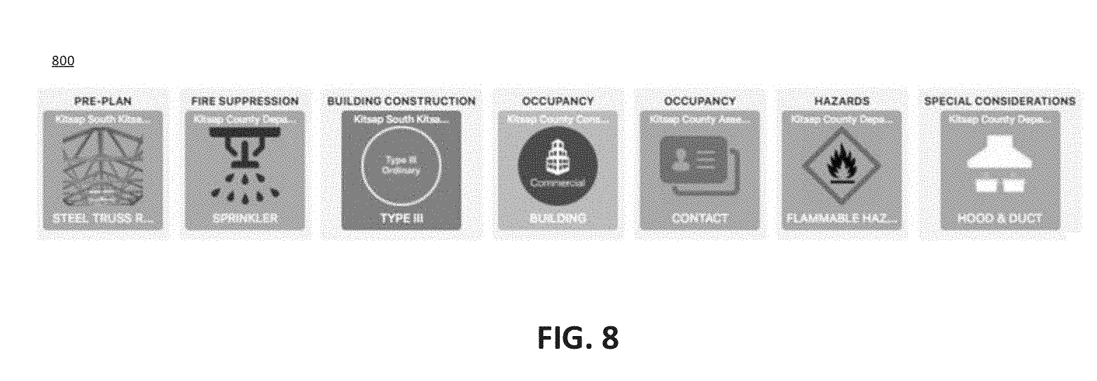

Example types of alert icon categories include an occupancy category, a consideration category, a building construction category, a pre-plan category, a fire-suppression category, a hazard category, and the like. With reference to FIG. 5, exemplary alert icons belonging to the occupancy category may include an alert icon 506 indicating an occupancy of the structure; alert icons belonging to the consideration category may include an alert icon 508 indicating whether the structure includes a solar panel, or an alert icon 510 indicating whether a swimming pool is located at or near the structure; and alert icons belonging to the building construction category may include an alert icon 512 indicating whether the structure is formed of a truss construction, an alert icon 514 indicating whether the structure is formed of concrete (or any other particular type of construction material, such as aluminum or vinyl siding, frame siding, brick masonry, timber), or an alert icon 516 indicating the nature of the roofing material included in the structure. Additional examples of the alert icon user interface elements 428f are shown in the user interface 800 of FIG. 8 and listed in Table 9 below.

TABLE 9

| Category | Alert Icon Label | Criteria |
|---|---|---|
| ALTERATION | INTERIOR | (permit.name “contains” ALTER INTERIOR) |
| ARRAYS | SOLAR PANEL | (permit.permit_type.name “contains” SOLAR |
| | | PANEL) |
| BUILDING | AUTO REPAIR | (prop.building_type “contains” AUTO-SERVICE) |
| BUILDING | RESTAURANT | (prop.building_type “contains” RESTAURANT) |
| BUILDING | ATTACH | (prop.attached_garage “is_not_empty” null) |
| CONSTRUCTION | GARAGE | |
| BUILDING | ATTACH | (prop.attached_garage “is_not_empty” null AND |
| CONSTRUCTION | GARAGE | prop.attached_garage “not_equal” 0) |
| BUILDING | ATTACH | (prop.attached_garage “contains” Yes) |
| CONSTRUCTION | GARAGE | |
| BUILDING | ATTACH | (unit.description “contains” ATT) |
| CONSTRUCTION | GARAGE | |
| BUILDING | ATTACH | (prop.attached_garage “is_not_empty” null) |
| CONSTRUCTION | GARAGE | |
| BUILDING | ATTACH | (prop.attached_garage “is_not_empty” null) |
| CONSTRUCTION | GARAGE | |
| BUILDING | ATTACH | (prop.attached_garage “equal” ATTACHED) |
| CONSTRUCTION | GARAGE | |
| BUILDING | ATTACH | (prop.attached_garage “equal” BUILT-IN) |
| CONSTRUCTION | GARAGE | |
| BUILDING | ATTIC | (prop.attic “is_not_empty” null) |
| CONSTRUCTION | | |
| BUILDING | ATTIC | (prop.attic “is_not_empty” null) |
| CONSTRUCTION | | |
| BUILDING | ATTIC | (permit.description “contains” attic) |
| CONSTRUCTION | | |
| BUILDING | BALLOON | (prop.year_built “less” 1920 AND prop.year_built |
| CONSTRUCTION | FRAME | “not_equal” 0) |
| BUILDING | BALLOON | (prop.year_built “less_or_equal” 1940) |
| CONSTRUCTION | FRAME | |
| BUILDING | BALLOON | (prop.year_built “less_or_equal” 1920) |
| CONSTRUCTION | FRAME | |
| BUILDING | BASEMENT | (prop.basement “is_not_empty” null) |
| CONSTRUCTION | | |
| BUILDING | BASEMENT | (prop.basement “is_not_empty” null) |
| CONSTRUCTION | | |
| BUILDING | BASEMENT | (prop.basement “is_not_empty” null) |
| CONSTRUCTION | | |
| BUILDING | BASEMENT | (prop.basement “is_not_empty” null) |
| CONSTRUCTION | | |
| BUILDING | BASEMENT | (prop.basement “not_equal” 0) |
| CONSTRUCTION | | |
| BUILDING | BRICK EXTERIOR | (prop.exterior_wall_type “equal” BRICK/MS) |
| CONSTRUCTION | | |
| BUILDING | CONCRETE | (prop.construction_class “contains” |
| CONSTRUCTION | | REINFORCED CONCRETE) |
| BUILDING | CONCRETE | (prop.construction_class “contains” |
| CONSTRUCTION | | REINFORCED CONCRETE, FIRE- |
| | | RESISTANT) |
| BUILDING | CONCRETE | (prop.construction_class “contains” |
| CONSTRUCTION | | REINFORCED CONCRETE) |
| BUILDING | CONCRETE | (prop.exterior_wall_type “equal” CONCRETE |
| CONSTRUCTION | EXTERIOR | BLK) |
| BUILDING | CONCRETE | (prop.exterior_wall_type “equal” CONC BLK/BL) |
| CONSTRUCTION | EXTERIOR | |
| BUILDING | DECKS | (prop.decks_porches “is_not_empty” null) |
| CONSTRUCTION | | |
| BUILDING | DETACH | (prop.detached_garage “is_not_empty” null) |
| CONSTRUCTION | GARAGE | |
| BUILDING | DETACH | (prop.detached_garage “is_not_empty” null) |
| CONSTRUCTION | GARAGE | |
| BUILDING | DETACHED | (prop.detached_garage “not_equal” 0) |
| CONSTRUCTION | GARAGE | |
| BUILDING | GARAGE | (permit.description “contains” garage) |
| CONSTRUCTION | | |
| BUILDING | HIGH RISE | (prop.building_type “contains” HIGH RISE) |
| CONSTRUCTION | | |
| BUILDING | MANUFACTURED | (permit.description “contains” MOBILE HOME) |
| CONSTRUCTION | HOME | |
| BUILDING | MASONRY/CONCRETE | (prop.construction_class “contains” MASONRY |
| CONSTRUCTION | | OR CONCRETE) |
| BUILDING | METAL ROOF | (prop.roof “equal” METAL) |
| CONSTRUCTION | | |
| BUILDING | MOBILE HOME | (prop.build_style “contains” MOBILE HOME) |
| CONSTRUCTION | | |
| BUILDING | ROOF | (permit.description “contains” roof) |
| CONSTRUCTION | | |
| BUILDING | ROOFING | (permit.description “contains” ROOF OR |
| CONSTRUCTION | | inspection.description “contains” ROOF OR |
| | | inspection.comments “contains” ROOF) |
| BUILDING | TRUSS | (permit.permit_type.name “contains” TRUSS OR |
| CONSTRUCTION | | permit.description “contains” TRUSS OR |
| | | permit.notes “contains” TRUSS OR |
| | | inspection.description “contains” TRUSS OR |
| | | inspection.comments “equal” TRUSS) |
| BUILDING | TRUSS | (permit.description “contains” TRUSS OR |
| CONSTRUCTION | | inspection.description “contains” TRUSS OR |
| | | inspection.comments “contains” TRUSS) |
| BUILDING | TRUSS | (permit.description “contains” TRUSS) |
| CONSTRUCTION | | |
| BUILDING | TRUSS | (permit.notes “contains” TRUSS) |
| CONSTRUCTION | | |
| BUILDING | TRUSS | (permit.description “contains” truss) |
| CONSTRUCTION | | |
| BUILDING | TRUSS | (permit.description “contains” truss) |
| CONSTRUCTION | | |
| BUILDING | STRUCTURAL | (permit.name “contains” S-STRUCTURAL |
| PERMIT | | MISCELLANEOUS) |
| BUILDING USE | APARTMENT | (prop.building_use “contains” APARTMENT OR |
| | | prop.building_use “contains” APT) |
| BUILDING USE | APARTMENT | (prop.building_use “contains” APARTMENT) |
| BUILDING USE | AUTO REPAIR | (prop.building_type “contains” AUTO REPAIR) |
| BUILDING USE | AUTO REPAIR | (prop.building_use “contains” COMMERCIAL |
| | | GARAGE REPAIR OR prop.building_use |
| | | “contains” AUTO DEALERS, SALES AND |
| | | SERVICE) |
| BUILDING USE | AUTO REPAIR | (prop.building_type “contains” Auto body (433) |
| | | OR permit.name “contains” Auto Repair) |
| BUILDING USE | BANK | (prop.building_use “contains” BANK) |
| BUILDING USE | BANK | (prop.building_type “contains” Bank (461) OR |
| | | permit.name “contains” Bank) |
| BUILDING USE | GAS STATION | (prop.building_type “contains” Gas station (432)) |
| BUILDING USE | HOSPITAL | (prop.building_use “contains” HOSPITAL) |
| BUILDING USE | HOTEL | (prop.building_type “contains” HOTEL OR |
| | | prop.buildingtype “contains” MOTEL) |
| BUILDING USE | HOTEL | (prop.building_use “contains” MOTEL OR |
| | | prop.building_use “contains” HOTEL) |
| BUILDING USE | RESTAURANT | (permit.name “contains” Restaurant) |
| BUILDING USE | RETAIL | (prop.building_use “contains” RETAIL) |
| BUILDING USE | SCHOOL | (prop.building_use “contains” COLLEGE OR |
| | | prop.building_use “contains” SCHOOL) |
| BUILDING USE | SUPERMARKET | (prop.building_use “contains” SUPERMARKET) |
| COMBUSTIBLE | FLAMMABLE | (permit.permit_type.name “contains” COMBUST |
| HAZARD | | OR permit.permit_type.name “contains” FLAM) |
| COMBUSTIBLE | FLAMMABLE | (permit.permit_type.name “contains” |
| HAZARD | | FLAMMABLE/COMBUSTIBLE) |
| CONSIDERATION | APARTMENT/CONDO | (prop.build_style “contains” CONDOMINIUM |
| | | AND prop.build_style “contains” APARTMENT) |
| CONSIDERATION | BANK | (prop.build_style “contains” BANK) |
| CONSIDERATION | Bldg Perm - | (permit.description “contains” Plumbing) |
| | Plumbing | |
| CONSIDERATION | BUILDING | (permit.permit_type.code “contains” Bldg Perm |
| | PERMIT | OR permit.permit_type.code “contains” Bldg Perm - |
| | | Furance OR permit.permit_type.code “contains” |
| | | Bldg Perm - Patio OR permit.description |
| | | “contains” furnace) |
| CONSIDERATION | CELL TOWER | (prop.building_use “contains” CELL TOWER) |
| CONSIDERATION | DAY CARE | (prop.build_style “contains” DAY CARE |
| | CENTER | CENTER) |
| CONSIDERATION | DECK/PORCH | (permit.permit_type.code “contains” Deck OR |
| | | permit.permit_type.code “contains” Porch OR |
| | | permit.description “contains” deck) |
| CONSIDERATION | ELECTRICAL | (permit.permit_type.code “contains” Bldg Perm - |
| | | Electrical) |
| CONSIDERATION | ELEVATOR | (permit.description “contains” Elevator OR |
| | | permit.permit_type.code “contains” Bldg Perm - |
| | | Elevator) |
| CONSIDERATION | FENCE | (permit.permit_type.code “contains” Bldg Perm - |
| | | Fence OR permit.description “contains” Fence OR |
| | | permit.description “contains” FENCE) |
| CONSIDERATION | FIREPLACE | (permit.permit_type.name “contains” |
| | | FIREPLACE) |
| CONSIDERATION | HOME FOR THE | (prop.build_style “contains” HOME FOR THE |
| | ELDERLY | ELDERLY AND prop.build_style “contains” |
| | | GROUP CARE HOME) |
| CONSIDERATION | HOOD & DUCT | (permit.description “contains” hood and duct OR |
| | | permit.description “contains” hood & duct) |
| CONSIDERATION | HOTEL/MOTEL | (prop.build_style “contains” HOTEL OR |
| | | prop.build_style “contains” MOTEL) |
| CONSIDERATION | MULTIPLE RES | (prop.build_style “contains” MULTIPLE RES) |
| CONSIDERATION | POOL | (permit.description “contains” POOL OR |
| | | permit.description “contains” Pool OR |
| | | permit.permit_type.code “contains” Bldg Perm - |
| | | Pool) |
| CONSIDERATION | RESTAURANT | (prop.build_style “contains” RESTAURANT) |
| CONSIDERATION | RETAIL CENTER | (prop.build_style “contains” SHOPPING AND |
| | | prop.build_style “contains” RETAIL) |
| CONSIDERATION | ROOF | (permit.description “contains” Roof) |
| CONSIDERATION | ROOFING WORK | (permit.description “contains” roof AND |
| | | permit.expiration date “last_90_days” null) |
| CONSIDERATION | SCHOOL | (prop.build_style “contains” SCHOOL OR |
| | | prop.build_style “contains” School OR |
| | | prop.build_style “contains” COLLEGE) |
| CONSIDERATION | SUPERMARKET | (prop.build_style “contains” SUPERMARKET) |
| CONSIDERATION | SWIMMING POOL | (permit.description “contains” pool) |
| CONSIDERATION | VACANT | (permit.description “contains” VACANT) |
| CONSIDERATION | VETERINARY | (prop.build_style “contains” VETERINARY |
| | HOSPITAL | HOSPITAL) |
| CONSIDERATION | WAREHOUSE | (prop.build_style “contains” WAREHOUSE) |
| CONSTRUCTION | ADDITION | (permit.name “equal” ADDITION) |
| CONSTRUCTION | MASONRY | (prop.construction_class “contains” MASONRY) |
| CONSTRUCTION | MOBILE HOME | (prop.building_type “contains” MOBILE) |
| CONSTRUCTION | ROOFING | (permit.name “contains” ROOF) |
| CONSTRUCTION | STEEL TRUSS | (prop.roof “contains” TRUSS, STEEL) |
| | ROOF | |
| ELECTRICAL | ELECTRICAL | (permit.description “contains” electrical) |
| EXTERIOR WALL | ALUM/VINYL | (prop.exterior_wall_type “contains” VINYL) |
| EXTERIOR WALL | ALUM/VINYL | (prop.exterior_wall_type “contains” |
| | | ALUM/VINYL) |
| EXTERIOR WALL | ALUM/VINYL | (prop.exterior_wall_type “contains” Alum/vinyl) |
| EXTERIOR WALL | ALUM/VINYL | (prop.exterior_wall_type “equal” Vinyl) |
| EXTERIOR WALL | BRICK | (prop.exterior_wall_type “contains” BRICK) |
| EXTERIOR WALL | BRICK | (prop.exterior_wall_type “contains” BRICK OR |
| | | prop.exterior_wall_type “contains” MASONRY) |
| EXTERIOR WALL | BRICK | (prop.exterior_wall_type “contains” Brick) |
| EXTERIOR WALL | CONCRETE | (prop.exterior_wall_type “contains” Concrete) |
| EXTERIOR WALL | CONCRETE/STONE | (prop.exterior_wall_type “contains” CONC |
| | | BLOCK OR prop.exterior_wall_type “contains” |
| | | STONE) |
| EXTERIOR WALL | FRAME | (prop.exterior_wall_type “contains” FRAME OR |
| | | EQUAL) |
| EXTERIOR WALL | LOG | (prop.exterior_wall_type “contains” LOG) |
| EXTERIOR WALL | MASONRY | (prop.construction_class “contains” MASONRY) |
| EXTERIOR WALL | MASONRY | (prop.exterior_wall_type “contains” MASONRY) |
| EXTERIOR WALL | MASONRY | (prop.exterior_wall_type “contains” MASONRY) |
| EXTERIOR WALL | MASONRY | (prop.exterior_wall_type “contains” |
| | | FRAME/MASONRY) |
| EXTERIOR WALL | MASONRY & | (prop.exterior_wall_type “contains” MASONRY) |
| | FRAME | |
| EXTERIOR WALL | STUCCO | (prop.exterior_wall_type “contains” STUCCO) |
| FIRE | FDC | (inspection.description “contains” FDC OR |
| SUPPRESSION | | inspection, comments “contains” FDC) |
| FIRE | FIRE HYDRANT | (inspection.description “contains” Hydrant) |
| SUPPRESSION | | |
| FIRE | SPRINKLER | (permit.permit_type.name “contains” |
| SUPPRESSION | | SPRINKLERS) |
| FIRE | SPRINKLER | (permit.description “contains” Sprinkler) |
| SUPPRESSION | | |
| FIRE | SPRINKLER | (prop.sprinkler_system “is_not_empty” null AND |
| SUPPRESSION | | prop.sprinkler_system “not_equal” 0) |
| FIRE | SPRINKLER | (permit.description “contains” SPRINKLER OR |
| SUPPRESSION | | inspection.description “contains” SPRINKLER |
| | | OR inspection.comments “contains” |
| | | SPRINKLER) |
| FIRE | SPRINKLER | (permit.name “contains” Sprinkler) |
| SUPPRESSION | | |
| FIRE | SPRINKLER | (inspection.description “contains” Sprinkler) |
| SUPPRESSION | | |
| FIRE | SPRINKLER | (permit.description “contains” sprinkler) |
| SUPPRESSION | | |
| FIRE | SPRINKLERS | (permit.description “contains” FIRE |
| SUPPRESSION | | SPRINKLERS) |
| FIRE | SPRINKLERS | (permit.description “contains” sprinkler OR |
| SUPPRESSION | | permit.description “contains” fire suppression) |
| FLAMM/COMBUST | COMPRESSED | (inspection.description “contains” COMPRESSED |
| | GAS | GAS OR inspection.comments “contains” |
| | | COMPRESSED GAS) |
| FLAMMABLE | LPG | (permit.permit_type.name “contains” LPG OR |
| COMBUSTIBLE | | permit.description “contains” LPG) |
| FLAMMABLE | LPG | (permit.name “contains” Construction: LPG Gas) |
| COMBUSTIBLE | | |
| FLAMMABLE | LPG | (permit.description “contains” LP GAS) |
| COMBUSTIBLE | | |
| FUEL | GAS | (permit.description “contains” gas) |
| FUEL TYPE | GAS | (permit.name “contains” GAS OR |
| | | permit.description “contains” GAS OR |
| | | permit.notes “contains” GAS OR |
| | | inspection.description “contains” GAS OR |
| | | inspection.comments “contains” GAS) |
| FUEL TYPE | GAS | (prop.fuel_type “contains” Natural Gas) |
| FUEL TYPE | GAS | (prop.fuel_type “equal” Gas) |
| FUEL TYPE | GAS FUEL | (prop.fuel_type “contains” GAS OR |
| | | permit.description “contains” GAS OR |
| | | permit.permit_type.name “contains” GAS) |
| FUEL TYPE | OIL | (prop.fuel_type “contains” Oil) |
| FUEL TYPE | OIL | (prop.fuel_type “equal” Oil) |
| FUEL TYPE | OIL FUEL | (prop.fuel_type “contains” OIL) |
| HAZARD | GAS STATION | (prop.building_type “contains” SERVICE |
| | | STATIONS) |
| HAZMAT | Flammable | (permit.description “contains” flammable) |
| HAZMAT | Hazardous | (permit.description “contains” hazardous material) |
| | Materials | |
| HAZMAT | HAZMAT | (hazmat.location “equal” Storage room) |
| HAZMAT | LPG | (permit.permit_type.name “contains” LP GAS) |
| HAZMAT | LPG | (permit.description “contains” liquefied petroleum |
| | | gas) |
| HAZMAT | TANK | (unit.description “contains” TANK) |
| NOT REPAIRED | VIOLATION | (violation.violation_type.name “contains” |
| | | VIOLATION AND |
| | | violation.violation_status_code “contains” Not |
| | | Repaired) |
| OBSTRUCTION | FENCE | (permit.permit_type.name “contains” FENCE) |
| OCCUPANCY | APARTMENT | (prop building_type “contains” Apartment (411)) |
| OCCUPANCY | APARTMENT | (prop build_style “contains” Apartment) |
| OCCUPANCY | ASSISTED | (prop build_style “contains” Convalescent/Nursing |
| | LIVING | Homes) |
| OCCUPANCY | AUTO REPAIR | (permit.description “contains” vehicle repair |
| | | garage, minor, operation OR permit.description |
| | | “contains” vehicle repair garage) |
| OCCUPANCY | BANK | (prop build_style “contains” Bank) |
| OCCUPANCY | COMMERCIAL | (prop.land_category “contains” COMMERCIAL) |
| OCCUPANCY | COMMERCIAL | (prop.building_type “contains” COMMERCIAL) |
| OCCUPANCY | COMMERCIAL | (prop.building_type “contains” COMMERCIAL) |
| OCCUPANCY | COMMERCIAL | (permit.description “contains” COMMERCIAL |
| | | BUILDING) |
| OCCUPANCY | COMMERCIAL | (permit.name “equal” COMMERCIAL BLDG |
| | | PERMIT) |
| OCCUPANCY | HOSPITAL | (prop.building_type “contains” PRIVATELY |
| | | OWNED HOSPITALS) |
| OCCUPANCY | HOTEL | (prop.building_type “contains” HOTEL) |
| OCCUPANCY | HOTEL | (prop.building_type “contains” Motel (415)) |
| OCCUPANCY | HOTEL | (prop.building_type “contains” Hotel (414)) |
| OCCUPANCY | HOTEL | (prop.build_style “contains” Hotel) |
| OCCUPANCY | RESIDENTIAL | (prop.building_type “contains” RESIDENTIAL) |
| OCCUPANCY | SCHOOL | (prop.building_type “contains” School (612)) |
| OCCUPANCY | SCHOOL | (prop build_style “contains” Schools) |
| OCCUPANCY | SINGLE FAMILY | (prop.building_type “contains” SINGLE |
| | | FAMILY) |
| OCCUPANCY | SINGLE FAMILY | (prop.building_type “contains” 1101-SINGLE |
| | | FAMILY DWELLING) |
| OCCUPANCY | SINGLE FAMILY | (prop.building_type “contains” 1 Family Res |
| | | (210)) |
| OCCUPANCY | SINGLE FAMILY | (prop.build_style “contains” SINGLE FAMILY |
| | | OR prop.building_use “contains” SINGLE |
| | | FAMILY) |
| OCCUPANCY | SINGLE FAMILY | (prop.building_type “equal” Single Family |
| | | Residential) |
| OCCUPANCY | SINGLE FAMILY | (permit.description “contains” SINGLE FAMILY) |
| OCCUPANCY | SINGLE-FAMILY | (prop.building_type “equal” SGL FAM RES) |
| OCCUPANCY | SINGLE-FAMILY | (prop build_style “contains” Dwelling) |
| OCCUPANCY | VACANT | (prop.building_type “contains” VACANT) |
| OCCUPANCY | WAREHOUSE | (prop.building_type “contains” WAREHOUSING) |
| PERMIT | ALTERATION | (permit.description “contains” ALTERATION) |
| PERMIT | ALTERATION | (permit.name “contains” ALTERATION) |
| PERMIT | BUILDING | (permit.name “contains” Addition) |
| | ADDITION | |
| PERMIT | BUILDING | (permit.name “contains” Alteration) |
| | ALTERATION | |
| PERMIT | COMPRESSED | (permit.description “contains” compressed gas) |
| | GAS | |
| PERMIT | DEMOLITION | (permit.name “contains” Demolition) |
| PERMIT | ELECTRICAL | (permit.name “equal” ELECTRICAL) |
| PERMIT | MECHANICAL | (permit.name “equal” HVAC/MECHANICAL) |
| PERMIT | PLUMBING | (permit.name “contains” Plumbing) |
| PERMIT | PLUMBING | (permit.name “equal” PLUMBING) |
| PERMIT | ROOFING | (permit.name “equal” ROOFING) |
| PERMIT WORK | ELECTRICAL | (permit.description “contains” ELECTRICAL OR |
| | | permit.name “contains” ELECTRICAL OR |
| | | permit.notes “contains” ELECTRICAL) |
| PRE-PLAN | ELECTICAL | (prop.electric “equal” Interior Service Room - #3 |
| | SHUTOFF | Side in Stock Room Area) |
| PRE-PLAN | FA CONTROL | (prop.fa_control_panel “equal” Electrical Room #1 |
| | PANEL | Side Far End Cash Register (Passcode |
| | | 13840929))) |
| PRE-PLAN | FDC | (prop.fd_connection “equal” Free Standing |
| | | Siamese - Corner #3/4 Side Near St) |
| ROOF | TRUSS STEEL | (prop.roof “contains” TRUSS STEEL) |
| SPECIAL | APARTMENT | (prop building_type “contains” APARTMENT) |
| CONSIDERATION | | |
| SPECIAL | ASSISTED | (prop.build_style “contains” ASSISTED LIVING |
| CONSIDERATION | LIVING | OR prop build_style “contains” SENIOR |
| | | CITIZEN) |
| SPECIAL | ASSISTED | (prop.building_use “contains” NURSING |
| CONSIDERATION | LIVING | HOMES) |
| SPECIAL | ATTIC | (prop.attic “is_not_empty” null AND prop.attic |
| CONSIDERATION | | “not_equal” 0) |
| SPECIAL | ATTIC | (permit.description “contains” ATTIC OR |
| CONSIDERATION | | inspection.description “contains” ATTIC OR |
| | | inspection, comments “contains” ATTIC) |
| SPECIAL | ATTIC | (prop.attic “contains” FULL) |
| CONSIDERATION | | |
| SPECIAL | BASEMENT | (prop.basement “is_not_empty” null AND |
| CONSIDERATION | | prop.basement “not_equal” 0) |
| SPECIAL | BASEMENT | (prop.basement “contains” FULL OR |
| CONSIDERATION | | prop.basement “contains” ¼ BSMT/SLAB OR |
| | | prop.basement “contains” ¾ BSMT OR |
| | | prop.basement “contains” ½ BSMT/CRAWL) |
| SPECIAL | CARPORT | (unit.unit_type.name “contains” CARPORT) |
| CONSIDERATION | | |
| SPECIAL | CARPORT | (permit.description “contains” S-CARPORT) |
| CONSIDERATION | | |
| SPECIAL | CELL TOWER | (permit.description “contains” CELL TOWER OR |
| CONSIDERATION | | permit.notes “contains” CELL TOWER OR |
| | | permit.permit_type.name “contains” CELL |
| | | TOWER) |
| SPECIAL | CELL TOWER | (permit.name “contains” Communication Tower/ |
| CONSIDERATION | | Ant) |
| SPECIAL | CELL TOWER | (permit.description “contains” cell tower) |
| CONSIDERATION | | |
| SPECIAL | DECK/PORCH | (unit.unit_type.name “contains” PORCH OR |
| CONSIDERATION | | unit.unit_type.name “contains” DECK) |
| SPECIAL | DECK/PORCH | (prop.decks_porches “contains” YES) |
| CONSIDERATION | | |
| SPECIAL | DECK/PORCH | (unit.description “contains” PORCH) |
| CONSIDERATION | | |
| SPECIAL | DECK/PORCH | (unit.description “contains” PORCH) |
| CONSIDERATION | | |
| SPECIAL | DECK/PORCH | (prop.decks_porches “is_not_empty” null) |
| CONSIDERATION | | |
| SPECIAL | DETACH | (prop.detached_garage “is_not_empty” null AND |
| CONSIDERATION | GARAGE | prop.detached_garage “not_equal” 0) |
| SPECIAL | DETACHED | (prop.detached_garage “contains” Yes) |
| CONSIDERATION | GARAGE | |
| SPECIAL | DETACHED | (unit.description “contains” DET) |
| CONSIDERATION | GARAGE | |
| SPECIAL | DOG ON | (inspection.description “contains” DOG OR |
| CONSIDERATION | PREMISES | inspection.comments “contains” DOG) |
| SPECIAL | ELEVATOR | (unit.unit_type.name “contains” ELEVATOR) |
| CONSIDERATION | | |
| SPECIAL | ELEVATOR | (unit.description “contains” ELEV) |
| CONSIDERATION | | |
| SPECIAL | ELEVATOR | (permit.name “contains” Elevator) |
| CONSIDERATION | | |
| SPECIAL | ELEVATOR | (permit.description “contains” elevator) |
| CONSIDERATION | | |
| SPECIAL | ELEVATOR | (permit.description “contains” elevator) |
| CONSIDERATION | | |
| SPECIAL | FENCE | (permit.description “contains” FENCE OR |
| CONSIDERATION | | inspection.description “contains” FENCE OR |
| | | inspection.comments “contains” FENCE) |
| SPECIAL | FENCE | (unit.description “contains” FENCE) |
| CONSIDERATION | | |
| SPECIAL | FENCE | (permit.name “contains” Fence) |
| CONSIDERATION | | |
| SPECIAL | FENCE | (permit.description “contains” fence) |
| CONSIDERATION | | |
| SPECIAL | FIRE ALARM | (permit.permit_type.code “contains” FIRE |
| CONSIDERATION | | ALARM) |
| SPECIAL | FIRE ALARM | (permit.description “contains” Alarm) |
| CONSIDERATION | | |
| SPECIAL | FIRE ALARM | (permit.description “contains” FIRE ALARM) |
| CONSIDERATION | | |
| SPECIAL | FIRE ALARM | (unit.unit_type.name “contains” FIRE ALARM) |
| CONSIDERATION | | |
| SPECIAL | FIRE ALARM | (permit.name “contains” Alarm/Detection) |
| CONSIDERATION | | |
| SPECIAL | FIRE ALARM | (inspection.description “contains” Fire Alarm) |
| CONSIDERATION | | |
| SPECIAL | FIRE ALARM | (permit.description “contains” FIRE ALARM) |
| CONSIDERATION | | |
| SPECIAL | FIRE ALARM | (permit.description “contains” fire alarm) |
| CONSIDERATION | | |
| SPECIAL | FIRE ALARM | (permit.description “contains” fire alarm) |
| CONSIDERATION | | |
| SPECIAL | FIRE PLACE | (inspection.comments “contains” FIRE PLACE |
| CONSIDERATION | | OR inspection.comments “contains” FIREPLACE) |
| SPECIAL | FLAMMABLE | (permit.permit_type.name “contains” |
| CONSIDERATION | FINISH | FLAMMABLE FINISH) |
| SPECIAL | FIREPLACE | (permit.description “contains” fireplace) |
| CONSIDERATION | | |
| SPECIAL | GAS STATION | (prop.building_type “contains” GAS) |
| CONSIDERATION | | |
| SPECIAL | GAS STATION | (prop.building_use “contains” GAS STATIONS) |
| CONSIDERATION | | |
| SPECIAL | GAS STATION | (prop.build_style “contains” Gas Station) |
| CONSIDERATION | | |
| SPECIAL | HAZMAT | (inspection.description “contains” HAZARDOUS |
| CONSIDERATION | | MATERIAL OR inspection.comments “contains” |
| | | HAZARDOUS MATERIAL) |
| SPECIAL | HOARDING | (violation, description “contains” hoard) |
| CONSIDERATION | | |
| SPECIAL | HOOD & DUCT | (inspection.description “contains” HOOD & |
| CONSIDERATION | | DUCT OR permit.description “contains” HOOD |
| | | AND DUCT OR inspection.comments “contains” |
| | | HOOD & DUCT OR inspection.comments |
| | | “contains” HOOD AND DUCT) |
| SPECIAL | HOOD & DUCT | (permit.permit_type.name “contains” HOOD & |
| CONSIDERATION | | DUCT OR permit.permit_type.name “contains” |
| | | HOOD DUCT OR permit.description “contains” |
| | | HOOD & DUCT OR permit.notes “contains” |
| | | HOOD & DUCT) |
| SPECIAL | HOOD&DUCT | (permit.name “contains” Construction (Hood Sys)) |
| CONSIDERATION | | |
| SPECIAL | HOSPITAL | (prop.building_type “contains” HOSPITAL OR |
| CONSIDERATION | | prop.build_style “contains” HOSP) |
| SPECIAL | MOBILE HOME | (prop.building_use “contains” MOBILE OR |
| CONSIDERATION | | MANUFACTURED HOME OR |
| | | prop.building_type “contains” MOBILE/MFG) |
| SPECIAL | POOL | (prop.pool “is_not_empty” null) |
| CONSIDERATION | | |
| SPECIAL | POOL | (prop.pool “is_not_empty” null) |
| CONSIDERATION | | |
| SPECIAL | POSSIBLE | (violation.description “contains” Hoard) |
| CONSIDERATION | HOARDING | |
| SPECIAL | ROOFING | (permit.description “contains” ROOF OR |
| CONSIDERATION | | permit.permit_type.name “contains” ROOF OR |
| | | permit.notes “contains” ROOF OR |
| | | inspection.description “contains” ROOF OR |
| | | inspection.comments “contains” ROOF) |
| SPECIAL | SCHOOL | (prop.building_type “contains” SCHOOL) |
| CONSIDERATION | | |
| SPECIAL | SOLAR | (permit.description “contains” solar panel OR |
| CONSIDERATION | | permit.description “contains” solarpanel OR |
| | | permit.description “contains” pv) |
| SPECIAL | SOLAR PANEL | (permit.description “contains” SOLAR PANEL |
| CONSIDERATION | | OR permit.notes “contains” SOLAR PANEL OR |
| | | inspection.description “contains” SOLAR PANEL |
| | | OR inspection.comments “contains” SOLAR |
| | | PANEL) |
| SPECIAL | SOLAR PANEL | (permit.description “contains” SOLAR PANEL |
| CONSIDERATION | | OR inspection.description “contains” SOLAR |
| | | PANEL OR inspection.comments “contains” |
| | | SOLAR PANEL) |
| SPECIAL | SOLAR PANEL | (permit.name “equal” SOLAR PANEL |
| CONSIDERATION | | INSTALLATION) |
| SPECIAL | SOLAR PANEL | (permit.description “contains” SOLAR PANEL) |
| CONSIDERATION | | |
| SPECIAL | SOLAR PANEL | (permit.description “contains” solar panel) |
| CONSIDERATION | | |
| SPECIAL | SPRAY BOOTH | (permit.permit_type.name “contains” SPRAY |
| CONSIDERATION | | PAINT OR permit.permit_type.name “contains” |
| | | SPRAY BOOTH) |
| SPECIAL | SPRAY BOOTH | (inspection.description “contains” SPRAY |
| CONSIDERATION | | BOOTH OR inspection.comments “contains” |
| | | SPRAY BOOTH) |
| SPECIAL | SPRINKLER | (prop.sprinkler_system “is_not_empty” null) |
| CONSIDERATION | | |
| SPECIAL | SWIMMING POOL | (prop.general_notes “contains” POOL) |
| CONSIDERATION | | |
| SPECIAL | SWIMMING POOL | (permit.permit_type.name “contains” POOL) |
| CONSIDERATION | | |
| SPECIAL | SWIMMING POOL | (permit.permit_type.name “contains” SWIMMING |
| CONSIDERATION | | POOL OR permit.description “contains” |
| | | SWIMMING POOL OR permit.notes “contains” |
| | | SWIMMING POOL) |
| SPECIAL | SWIMMING POOL | (permit.description “contains” POOL OR |
| CONSIDERATION | | inspection.description “contains” POOL OR |
| | | inspection.comments “contains” POOL) |
| SPECIAL | SWIMMING POOL | (prop.pool “contains” Yes) |
| CONSIDERATION | | |
| SPECIAL | SWIMMING POOL | (unit.description “contains” POOL) |
| CONSIDERATION | | |
| SPECIAL | SWIMMING POOL | (permit.name “contains” Pool) |
| CONSIDERATION | | |
| SPECIAL | SWIMMING POOL | (permit.description “contains” POOL) |
| CONSIDERATION | | |
| SPECIAL | VACANT | (prop.building_type “contains” Vacant) |
| CONSIDERATION | | |
| SPECIAL | WELDING | (permit.permit_type.name “contains” WELDING |
| CONSIDERATION | | OR permit.description “contains” WELDING OR |
| | | permit.notes “contains” WELDING) |
| SPECIAL | WELDING | (permit.description “contains” hot work |
| CONSIDERATION | | operations, welder, cut, weld, grind, braze, solder, |
| | | conduct) |
| STORAGE | HIGH PILED | (violation.description “contains” blocking |
| VIOLATION | | emergency paths) |
| SUPPRESSION | AUTO FIRE EXT | (permit.permit_type.name “contains” AUTO FIRE |
| | | EXT) |
| VIOLATION | DOG | (violation.description “contains” dog) |
| VIOLATION | MISSING TILE | (violation.description “contains” Missing Ceiling |
| | | Tile) |
| VIOLATION | SPRINKLER | (violation.description “contains” sprinkler) |
| VIOLATION | SPRINKLER_VIOLATION | (violation.description “contains” Sprinkler) |
| VIOLATION | WELDING | (violation.description “contains” welding) |
| VIOLATION/COMPLAINT | BOILER | (violation.description “contains” boiler) |
| VIOLATION/COMPLAINT | DANGEROUS! | (violation.description “contains” dangerous) |
| VIOLATION/COMPLAINT | ELECTRICAL | (violation.description “contains” electrical) |
| VIOLATION/COMPLAINT | ELEVATOR | (violation.description “contains” elevator) |
| VIOLATION/COMPLAINT | FDC | (violation.description “contains” fd connection) |
| VIOLATION/COMPLAINT | FENCE | (violation.description “contains” fence) |
| VIOLATION/COMPLAINT | FIRE ALARM | (violation.description “contains” fire alarm) |
| VIOLATION/COMPLAINT | FIRE | (violation.description “contains” extinguisher) |
| | EXTINGUISHER | |
| VIOLATION/COMPLAINT | FLAMMABLE | (violation.description “contains” combustibles) |
| VIOLATION/COMPLAINT | GAS BUILDING | (violation.description “contains” gas) |
| VIOLATION/COMPLAINT | HAZARD | (violation.description “contains” hazard materials) |
| | MATERIALS | |
| VIOLATION/COMPLAINT | LIGHTING | (violation.description “contains” illumination) |
| VIOLATION/COMPLAINT | POSSIBLY | (violation.description “contains” vacant) |
| | VACANT | |
| VIOLATION/COMPLAINT | RETAINING | (violation.description “contains” retaining wall) |
| | WALL | |
| VIOLATION/COMPLAINT | ROOF | (violation.description “contains” roof) |
| VIOLATION/COMPLAINT | SPRINKLER | (violation.description “contains” sprinkler) |
| VIOLATION/COMPLAINT | STANDPIPE | (violation.description “contains” standpipe) |
| WALLS | STUCCO | (prop.exterior_wall_type “contains” C.B. |
| | EXTERIOR | STUCCO) |

As shown in Table 9 above, each of the criteria may include a data field identifier that includes a data field category (for example, “permit”) and a data field parameter (for example, “name”). Table 10 shows additional examples of types of data field categories and data field parameters that may be employed in various embodiments.

TABLE 10

| | |
|---|---|
| Data Field | |
| Category | Data Field Parameter |

Residential Properties

| | |
|---|---|
| Place Upload | Xref Id |
| Place Upload | Address 1 |
| Place Upload | Address 2 |
| Place Upload | City |
| Place Upload | County |
| Place Upload | State Code |
| Place Upload | Zip |
| Place Upload | Latitude |
| Place Upload | Longitude |
| Place Upload | Parcel Key |
| PROP Upload | Xref Id |
| PROP Upload | Address |
| PROP Upload | Name |
| PROP Upload | Acres |
| PROP Upload | Lot Depth |
| PROP Upload | Lot Frontage |
| PROP Upload | Number of Stories |
| PROP Upload | Attached Garage |
| PROP Upload | Attic |
| PROP Upload | Basement |
| PROP Upload | Build Style |
| PROP Upload | Building Type |
| PROP Upload | Building Use |
| PROP Upload | Building Value |
| PROP Upload | Condition |
| PROP Upload | Construction Class |
| PROP Upload | Cooling |
| PROP Upload | Decks Porches |
| PROP Upload | Detached Garage |
| PROP Upload | Electric |
| PROP Upload | Elevator |
| PROP Upload | Exterior Wall Type |
| PROP Upload | FA Control Panel |
| PROP Upload | FD Connection |
| PROP Upload | Fire Alarm |
| PROP Upload | Floor |
| PROP Upload | Fuel Type |
| PROP Upload | Full Bathrooms |
| PROP Upload | Gas |
| PROP Upload | General Notes |
| PROP Upload | Generator |
| PROP Upload | Half Bathrooms |
| PROP Upload | Heat Type |
| PROP Upload | Land Category |
| PROP Upload | Lightweight |
| | Construction |
| PROP Upload | Living Area Square |
| | Feet |
| PROP Upload | Lot Square Footage |
| PROP Upload | Number of Bedrooms |
| PROP Upload | Number of Rooms |
| PROP Upload | Photo URL |
| PROP Upload | Pool |
| PROP Upload | Property Class |
| PROP Upload | Property Sketch URL |
| PROP Upload | Property Status |
| PROP Upload | Roof |
| PROP Upload | Sprinkler System |
| PROP Upload | Year Built |
| PROP Upload | Year Remodeled |
| PROP Upload | Parcel Key |
| Permits | Xref Id |
| Permits | Address |
| Permits | Permit Type Code |
| Permits | Name |
| Permits | Location |
| Permits | Description |
| Permits | Issue Date |
| Permits | Expiration Date |
| Permits | Approved Date |
| Permits | Status |
| Inspections | Xref Id |
| Inspections | Address |
| Inspections | Inspection Type Code |
| Inspections | Inspection Date |
| Inspections | Description |
| Inspections | Comments |
| Inspections | Status |
| Violations | Xref Id |
| Violations | Address |
| Violations | Violation Type Code |
| Violations | Incident Date |
| Violations | Description |
| Violations | Status |
| Hazmat | Xref Id |
| Hazmat | Address |
| Hazmat | Hazmat Type Code |
| Hazmat | Quantity |
| Hazmat | Quantity Type |
| Hazmat | Storage Location |
| Units | Xref Id |
| Units | Address |
| Units | Unit Type Code |
| Units | Year Built |
| Units | Description |
| Units | Gross Area |
| Units | Latitude |
| Units | Longitude |
| Units | Status |
| Contacts | Xref Id |
| Contacts | Address |
| Contacts | Contact Type Code |
| Contacts | First Name |
| Contacts | Last Name |
| Contacts | Name |
| Contacts | Location |
| Contacts | Phone |
| Contacts | Mobile |
| Contacts | Email |
| Contacts | Notes |
| PROP Photo | Xref Id |
| Upload | |
| PROP Photo | Prop Id |
| Upload | |
| PROP Photo | URL |
| Upload | |
| PROP Photo | Taken Date |
| Upload | |
| PROP Photo | Position |
| Upload | |

Commercial Properties

| | |
|---|---|
| General Pre-Plan | Business |
| General Pre-Plan | Business Type |
| General Pre-Plan | Width |
| General Pre-Plan | Length |
| General Pre-Plan | Height |
| General Pre-Plan | Area |
| General Pre-Plan | Floors |
| General Pre-Plan | Age |
| General Pre-Plan | Year Built |
| General Pre-Plan | Exp. #1 |
| General Pre-Plan | Roof |
| General Pre-Plan | Walls |
| General Pre-Plan | Floors |
| General Pre-Plan | Basement |
| General Pre-Plan | Base Access 1 |
| General Pre-Plan | Base Access 2 |
| General Pre-Plan | Fence |
| General Pre-Plan | Solar Panel |
| General Pre-Plan | Warning |
| General Pre-Plan | Last Inspected |
| FDC | Type |
| FDC | Location |
| FDC | Connection Type |
| FDC | Connection Size |
| FDC | Description |
| Standpipe | Type |
| Standpipe | Control Valve |
| | Location |
| Standpipe | Hose valve locations |
| Standpipe | PRVs |
| Standpipe | Description |
| Suppression System | Type |
| Suppression System | Riser valve locations |
| Suppression System | Is Automatic? |
| Suppression System | Coverage |
| Suppression System | Manual activation |
| Suppression System | Shut-off |
| Suppression System | Activation Hazard |
| Suppression System | Description |
| Alarm Panel | Type |
| Alarm Panel | Location |
| Alarm Panel | Code |
| Alarm Panel | Can Reset? |
| Alarm Panel | Description |
| Alarm System | Type |
| Alarm System | Company |
| Alarm System | Permit |
| Alarm System | Make |
| Alarm System | Automatic Dialer |
| Alarm System | Description |
| Fire Pump | Type |
| Fire Pump | Location |
| Fire Pump | Operating Pressure |
| Fire Pump | Flow Capacity |
| Fire Pump | Power Source |
| Fire Pump | Permit Issued |
| Fire Pump | Description |
| Knox Box | Location |
| Knox Box | Code |
| Knox Box | Description |
| Utilities | Type |
| Utilities | Service Info |
| Utilities | Shut-Off location |
| Utilities | Description |

Miscellaneous

| | |
|---|---|
| Hydrant | Latitude/Longitude |
| Hydrant | Flow Rate |
| Hydrant | Fitting Type |
| Hydrant | Fitting Size |

In some embodiments, the description herein of how the data management platform 104 determines whether a particular alert icon is applicable to a structure or address corresponding to the emergency call, and thus whether the particular alert icon is to be displayed via the user interface 500, by determining whether data aggregated at block 404 and/or block 424 satisfies one or more corresponding criteria, is similarly applicable to how the data management platform 104 determines which information to include in the textual description user interface element 428e, which may be configurable by way of the user interface 2100.

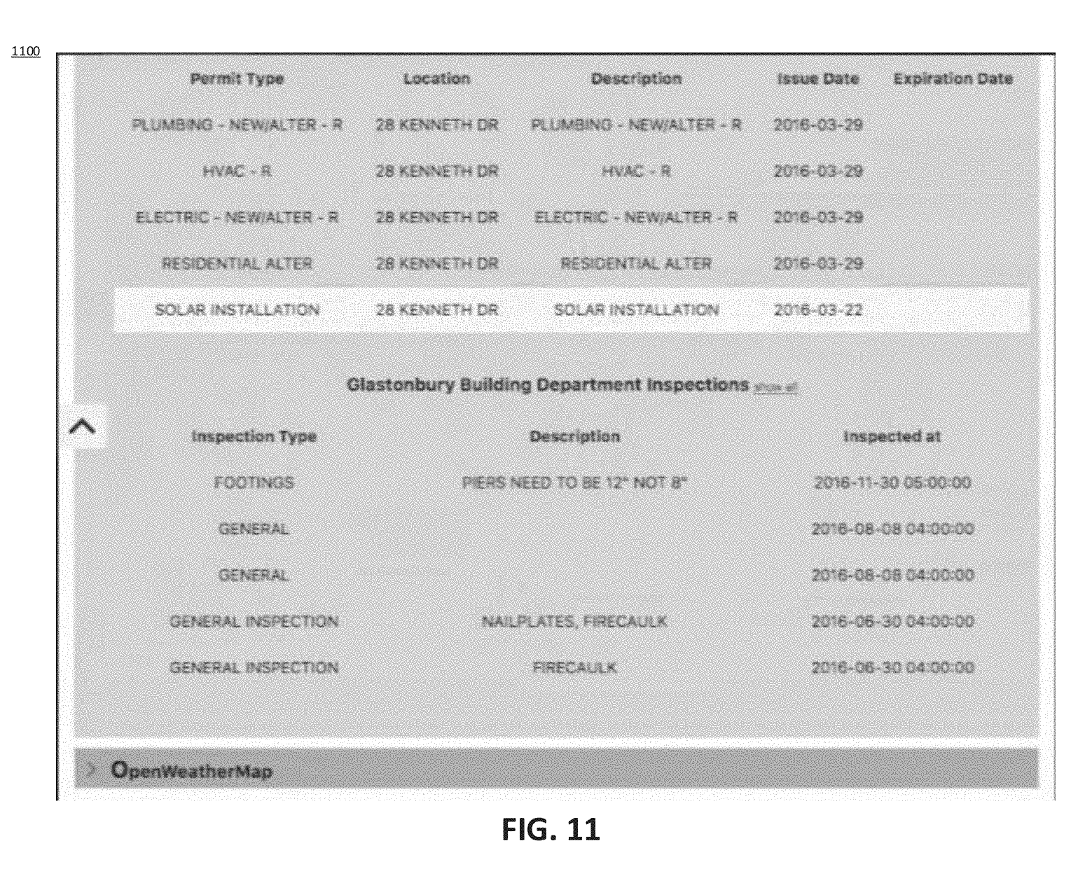

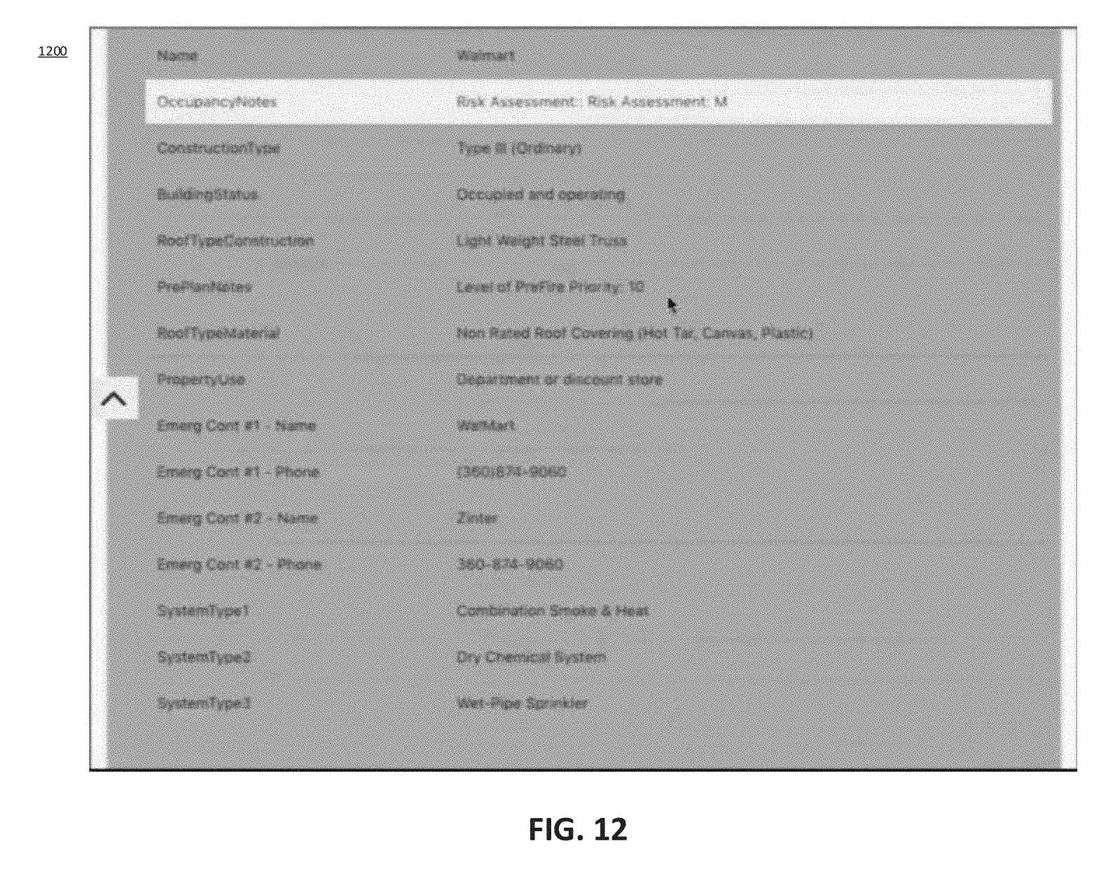

In some embodiments, each alert icon is selectable to cause data that is stored in the database layer 206 and that relates to the particular alert icon to be aggregated and displayed, for example, via a pop-up window. In some examples, the alert icon 508 indicating whether the structure includes a solar panel is selectable to cause the display of source-specific data 1100 regarding the solar panel, as shown in FIG. 11. In some examples, the alert icon 506 indicating an occupancy of the structure is selectable to cause the display of source-specific data 1200 regarding the occupancy of the structure, as shown in FIG. 12.

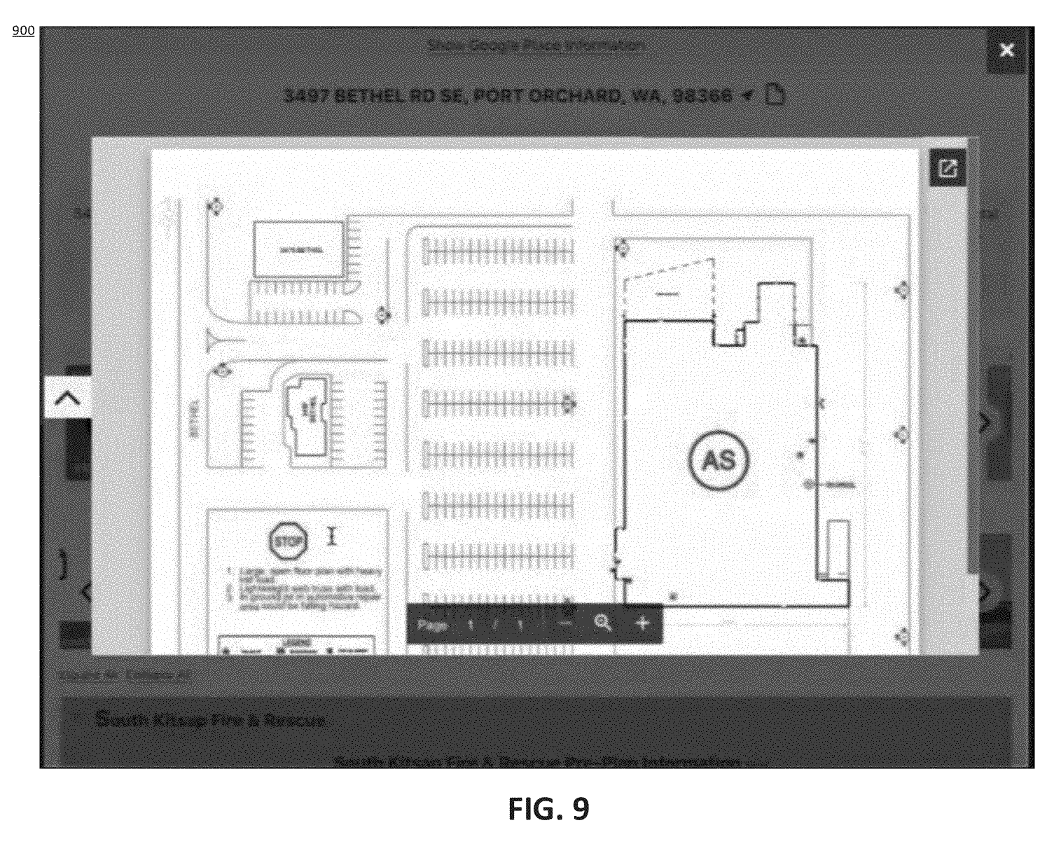

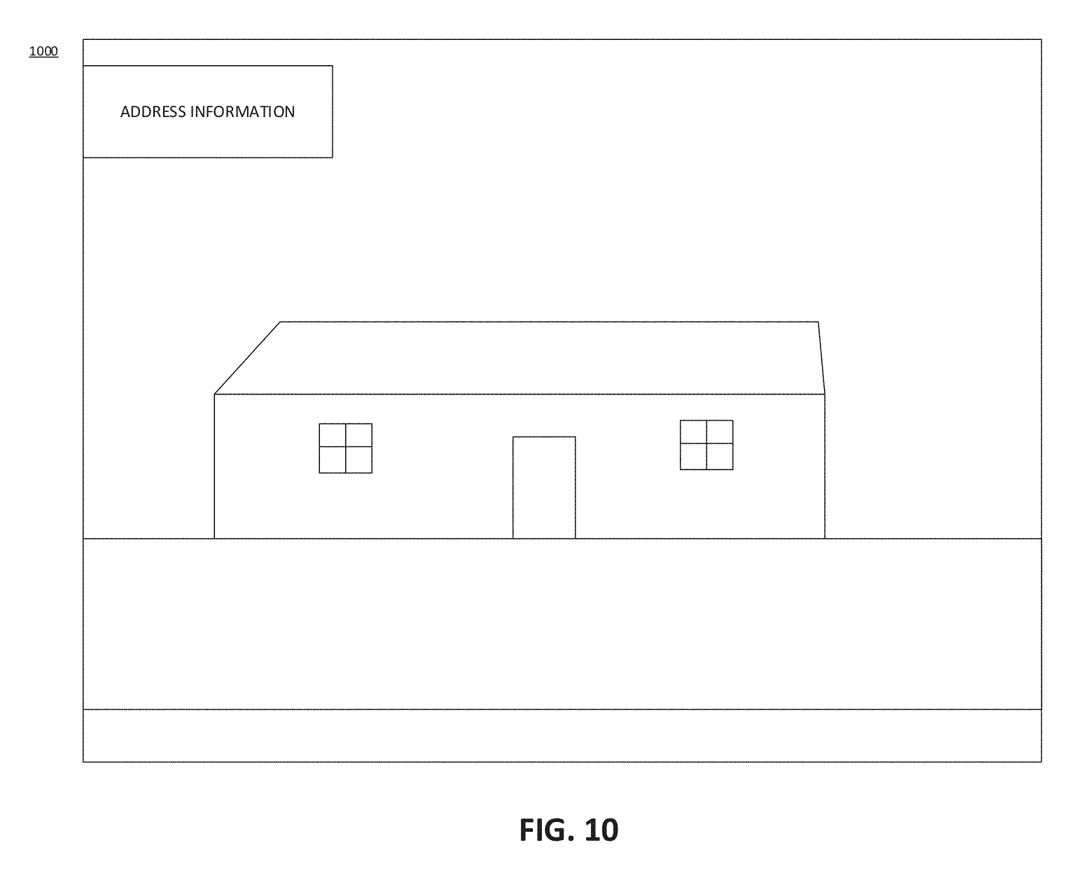

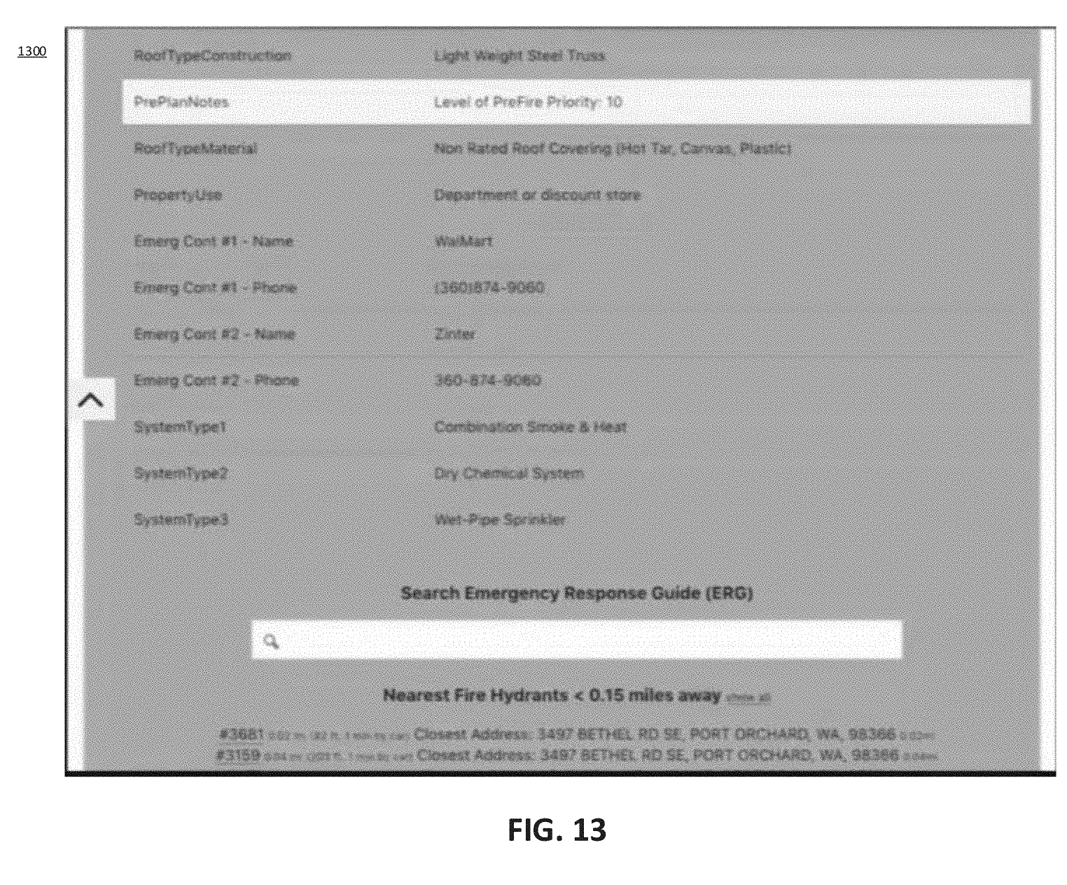

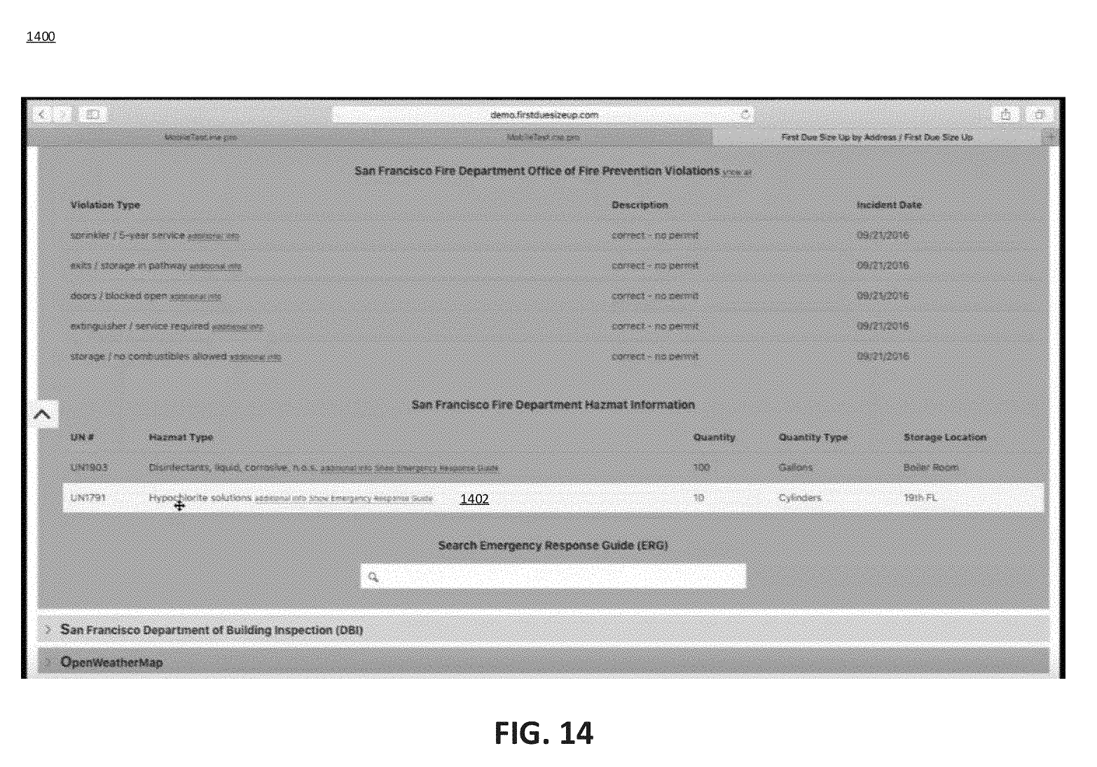

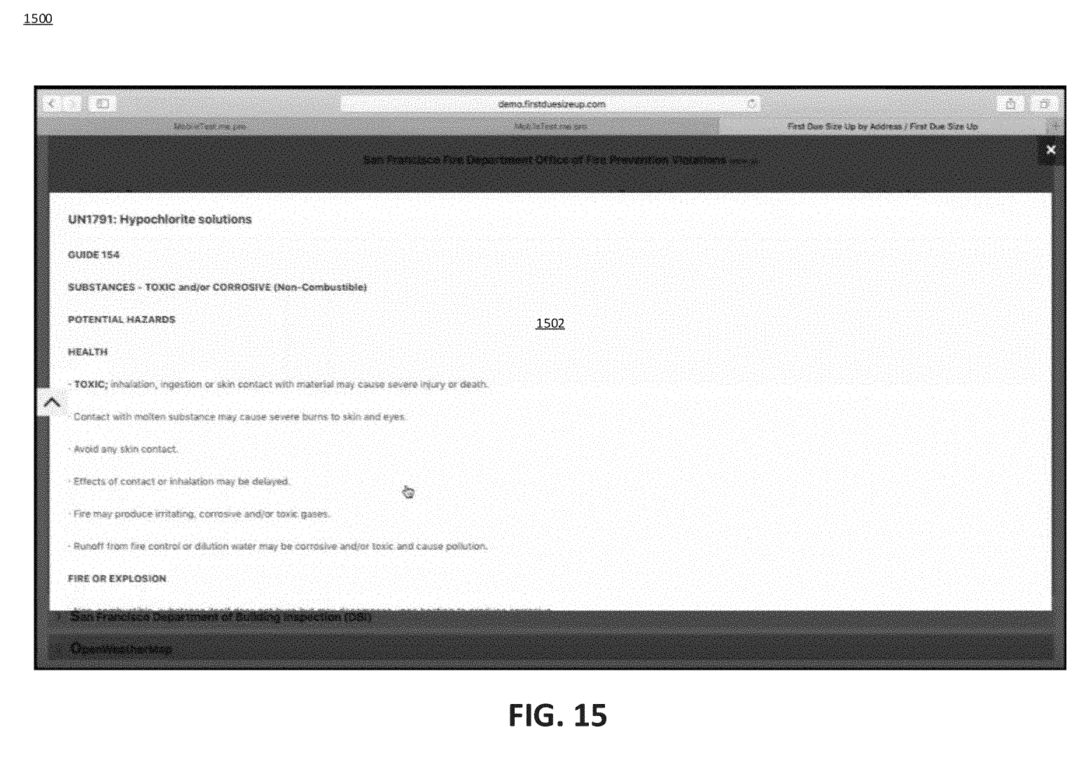

The visual user interface elements 428g are selectable to cause the visual user interface elements 428g to be expanded into a larger view, for example, via a popup window, to present information to the first responder. Exemplary types of the visual user interface elements 428g include, without limitation, a street view user interface element 518, a roof image user interface element 520, a property sketch user interface element 522, a hazardous material user interface element (not shown in FIG. 5), a social media feed user interface element (not shown in FIG. 5), a nearest cameras user interface element (not shown in FIG. 5), a nearest hydrants user interface element (not shown in FIG. 5), and/or the like. The street view user interface element 518, in some examples, is selectable to cause the display of a larger street view 1000 of the structure located at the address of the emergency response, as shown in FIG. 10. The property sketch user interface element 522, in some examples, is selectable to cause the display of a property sketch 900 of the structure located at the address of the emergency response, as shown in FIG. 9. The hazardous material user interface element (not shown in FIG. 5), in some embodiments, is selectable to cause display of a user interface 1400 including a table entry 1402 providing information about a hazardous material that is known or expected to be located at the location of the emergency response, as shown in FIG. 14. The table entry 1402 is selectable to cause display of a popup window 1500, as shown in FIG. 15, that includes even more detail 1502 regarding the hazardous material and/or standard procedures for handling the hazardous material. Although not shown in FIG. 5, in some embodiments, the alert icon user interface elements 428f include a pre-plan user interface element, that is selectable to cause display of a user interface 1300 that includes details regarding pre-plan information, as shown in FIG. 13.

The source-specific data user interface elements 428h include data source-specific information sections, which are each selectable to display detailed information coming from one of the data sources 102. Exemplary types of the source-specific data user interface elements 428h include a fire department section that provides information obtained from a fire department data source, a property assessor section that provides information obtained from a property assessor data source, a building department section that provides information obtained from a building department data source, a weather section that provides information obtained from a weather data source, a fire prevention section, a community section, a government agency section, and the like.

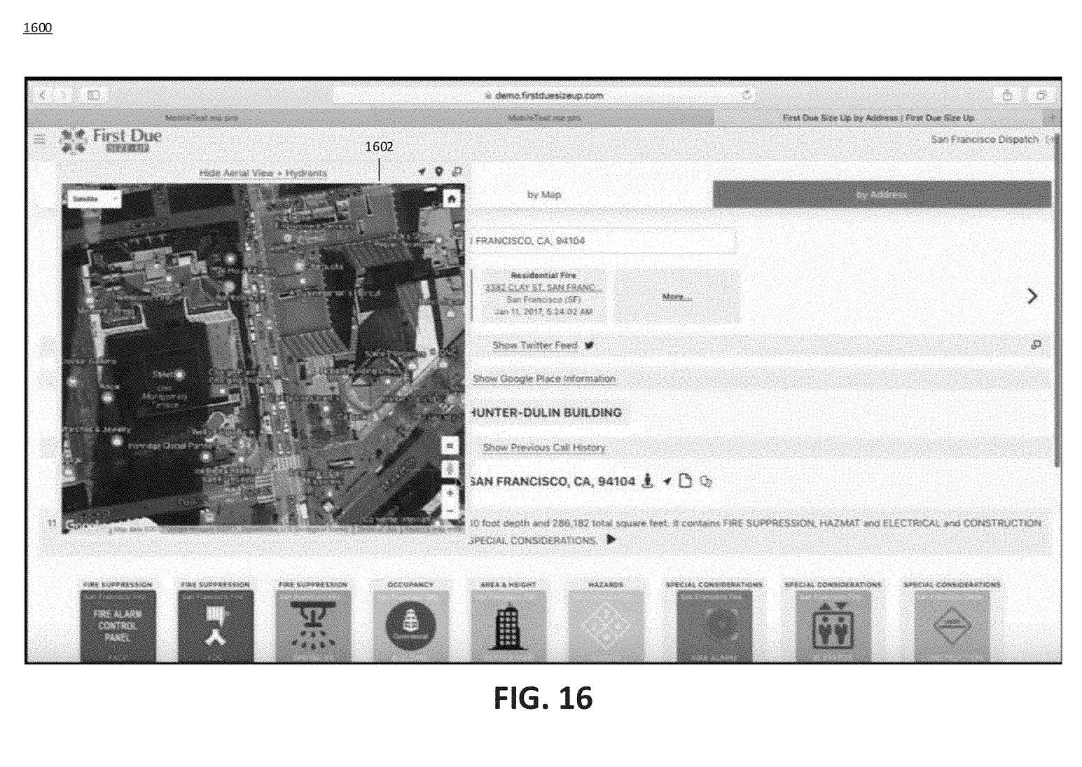

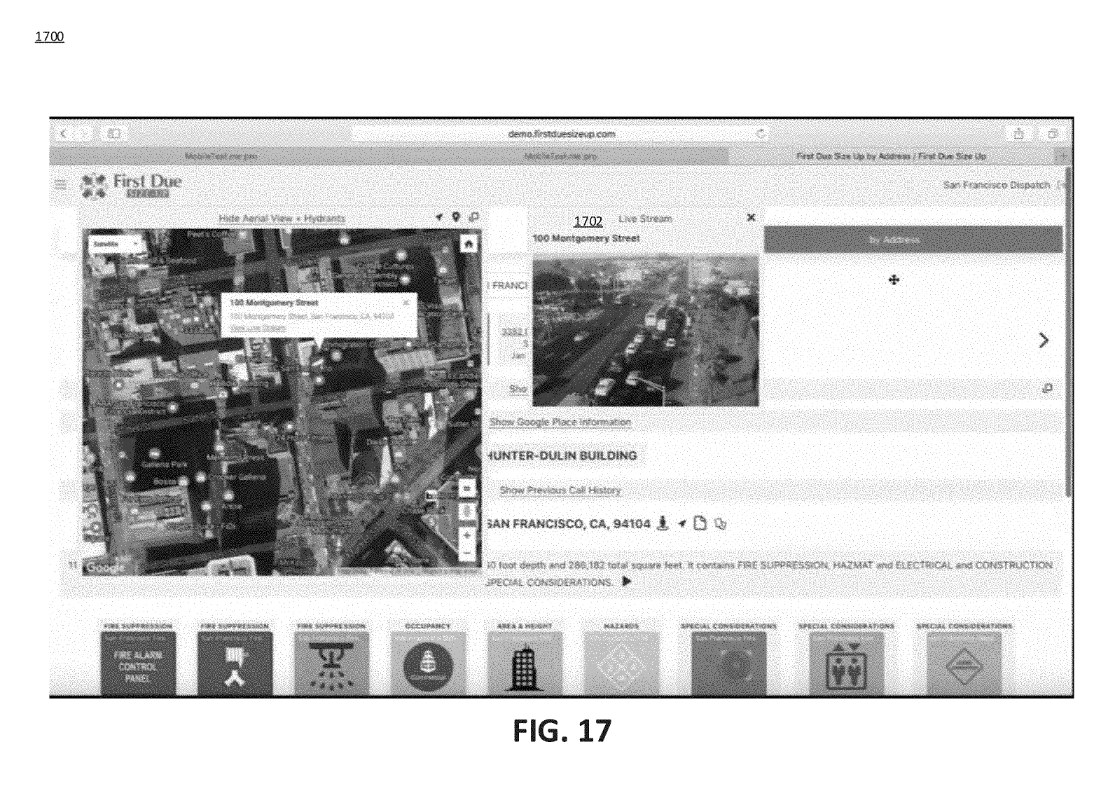

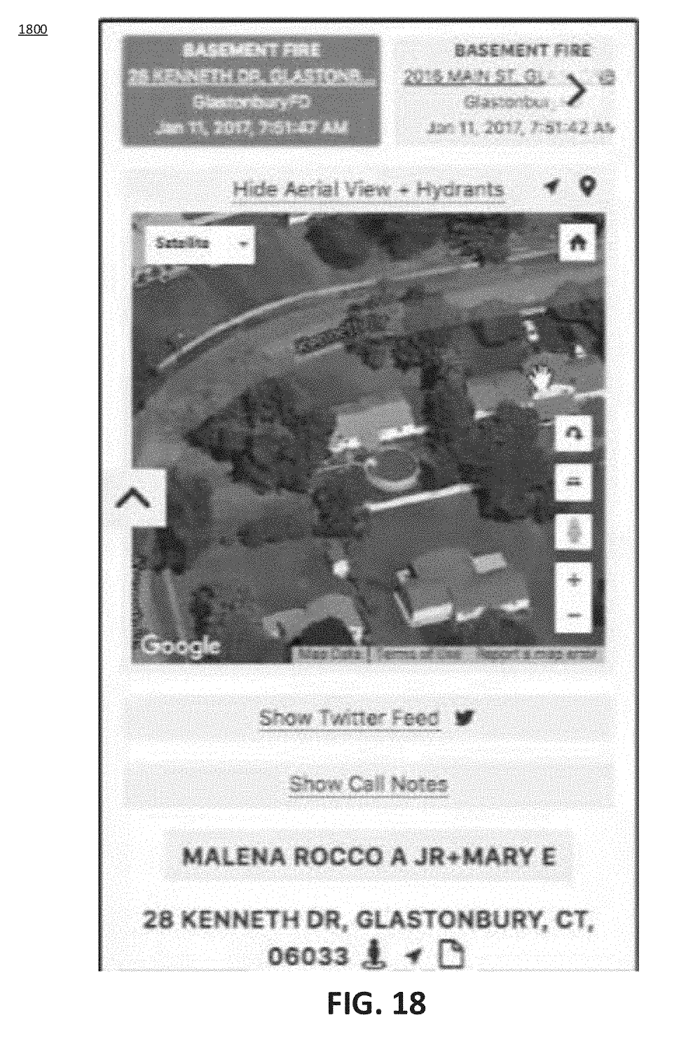

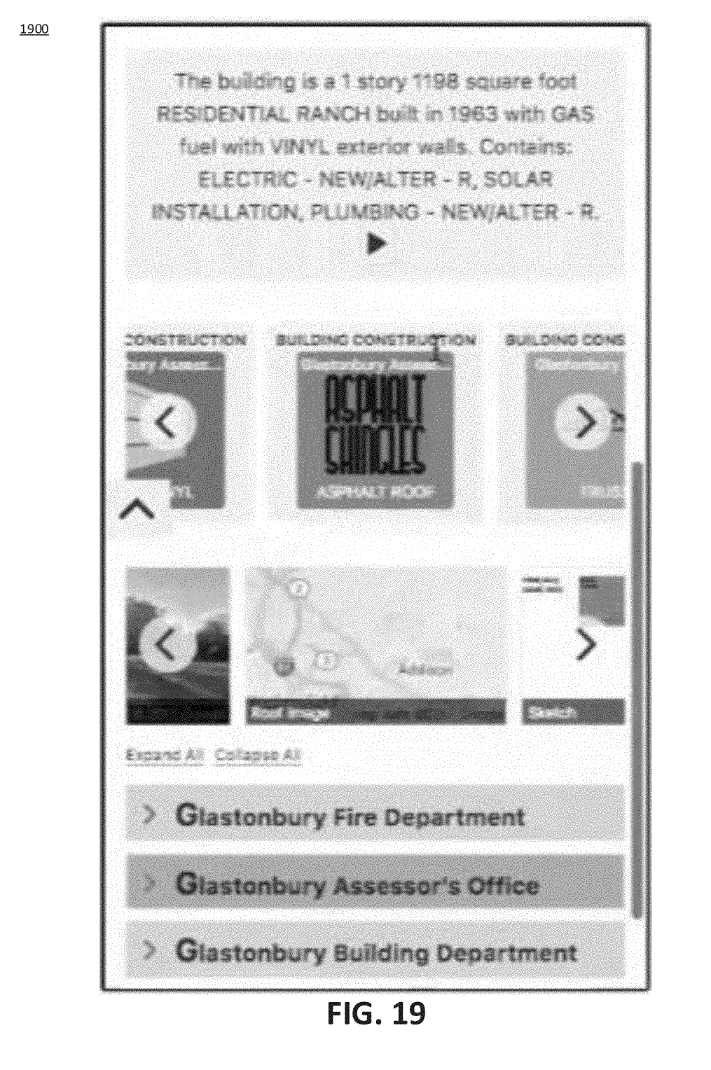

In some embodiments, the data management platform 104 provides the various user interfaces to be displayed via the user devices 106 in a size and/or format that is supported by the user device 106, thereby ensuring proper display of information to the user. For example, FIG. 16 and FIG. 17 show user interfaces 1600 and 1700, respectively, that may be provided to user device 106, such as a personal laptop computer, that includes a large format display device. FIG. 18 and FIG. 19 show user interfaces 1800 and 1900, respectively, that may be provided to a user device 106, such as a smart phone, that includes a small format display device. Further, the user interface 1600, in some examples, includes an aerial view 1602 including an overlay (for example, based on a GIS layer) that indicates locations of video cameras at the location of the emergency. The cameras are selectable to cause the display of a live video feed 1702, as shown in FIG. 17.

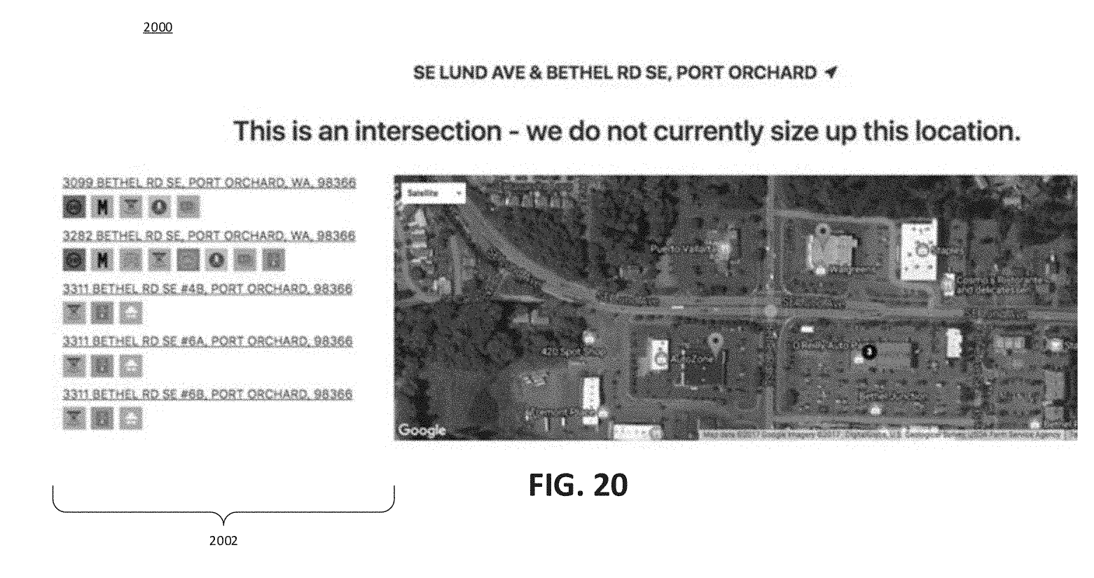

In some embodiments, if an address corresponding to an emergency call is an intersection instead of a residential or commercial structure address, a user interface 2000 is displayed indicating such, as shown in FIG. 20. The user interface 2000 includes a section 2002 in which multiple addresses and corresponding alert icons are displayed for addresses located in the vicinity of the intersection. The data management platform 104 may be configured to provide similar functionality in cases where an address corresponding to an emergency call is an address of a subunit of a building that includes multiple subunits. In such a scenario, for instance, the data management platform 104 may be configured to provide information for the individual subunit, for the building as a whole, and/or for both the individual subunit and the building as a whole.

FIG. 21 includes an example of a user interface 2100 that may be provided by way of the configuration device 108 to enable an account administrator to configure how the textual description user interface element 428e is generated and/or what information it includes. For example, the user interface 2100 includes sub-elements that may be utilized to generate one or more user interface rules, such as the user interface rules described above in connection with block 426, to be utilized at block 428 in generating the textual description user interface element 428e.

FIG. 22 includes an example of a user interface 2200 that may be provided by way of the configuration device 108 to enable an account administrator to configure how the alert icon user interface elements 428f are generated and/or what information they provide. For example, the user interface 2200 includes sub-elements that may be utilized to generate one or more user interface rules, such as the user interface rules described above in connection with block 426, to be utilized at block 428 in generating the alert icon user interface elements 428f.

In some embodiments, the data management platform 104 is configured to determine, based on data aggregated at block 404 and/or 424, whether certain conditions are satisfied, and provide, via the user interface 500 for instance, contextual recommendations or warnings to first responders based on a result of the determination. For instance, the textual description user interface element 428e may be modified in content or to include emphasis (e.g., highlighting) of specific components thereof (which may be pre-defined through the user interface 2100 and/or based on one or more standard operating procedures (SOPs) entered into the data management platform 104 by an account administrator via the configuration device 108) based on any of a variety of factors, such as, by way of example, incident type, time of day, time since incident, type of structure, type of unit responding, user responding, role of responder, previous call history, and/or the like. In other embodiments, the appearance, order of arrangement, and/or emphasis of alert icon user interface elements 428f (which may be pre-defined through the user interface 2200 and/or based on SOPs entered into the data management platform 104 by an account administrator via the configuration device 108) based on any of a variety of factors, such as, by way of example, incident type, time of day, time since incident, type of structure, type of unit responding, user responding, role of responder, previous call history, and/or the like. In another example, the data management platform 104 may generate and display pop-up warning alerts (which may be pre-defined through the configuration device 108 and/or based on SOPs entered into the data management platform 104 by an account administrator via the configuration device 108) based on any of a variety of factors, such as, by way of example, incident type, time of day, time since incident, type of structure, type of unit responding, user responding, role of responder, previous call history and aggregated data related to the address or structure corresponding to the emergency call. Further, a page layout of a user interface (e.g., user interface 500) may be dynamically modified (in accordance with rules pre-defined through the configuration device 108 and/or based on SOPs entered into the data management platform 104 by an account administrator via the configuration device 108) based on any of a variety of factors, such as incident type, time of day, time since incident, type of structure, type of unit responding, user responding, role of responder, previous call history and aggregated data related to the address or structure corresponding to the emergency call.

TABLE 11

| | Recommendation/ | |
|---|---|---|
| Condition | Warning Type | Recommendation/Warning |
| Alert Tile for Vacant | Warning/Alert Box | “This building is potentially |
| Occupancy, | | Vacant. Assess before entering. |
| Incident Type = Fire | | Potential Exterior Firefighting |
| | | Only” |
| Alert Tile for Vacant | Alert Tile | Highlight Vacant Tile |
| Occupancy, | | |
| Incident Type = Fire | | |
| Duration since incident start is | Alert Tile | Rearrange Alert Tiles so that all |
| less than 10 minutes | | Tiles related to water source are |
| | | first |
| Alert Tile for Truss | Warning/Alert Box | “Possible Roof Collapse risk. |
| Construction on Roof and | | Avoid roof ventilation” |
| Roofing work and building | | |
| Type is residential | | |
| Alert Tile for Attic/Basement | Warning/Alert Box | “Potential life hazard in basement |
| and Occupancy related | | or attic” |
| violation, building Type is | | |
| Residential, incident type is | | |
| related to fire/smoke | | |
| Structure Fire, Commercial | Warning/Alert Box | “Combustible material/hazards |
| Building, another building | | within surrounding exposures” |
| within small radius has alert tile | | |
| for combustible material, | | |
| incident type gas, smoke or fire | | |
| Structure Fire, Commercial | Page Layout | Move Exposures button to top |
| Building, another building | | and highlight |
| within small radius has alert tile | | |
| for combustible material, | | |
| incident type gas, smoke or fire | | |
| Structure Fire, Residential | Alert Tile | Highlight Possible Balloon |
| Building, Year built is earlier or | | Frame Construction |
| less than the year 1940, Incident | | |
| type gas, smoke or fire | | |

The embodiments disclosed herein are examples of the present information systems and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present information systems in virtually any appropriately detailed structure. Like reference numerals may refer to similar or identical elements throughout the description of the figures.

The phrases “in an embodiment,” “in embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

The systems and/or methods described herein may utilize one or more controllers to receive various information and transform the received information to generate an output. The controller may include any type of computing device, computational circuit, or any type of processor or processing circuit capable of executing a series of instructions that are stored in a memory. The controller may include multiple processors and/or multicore central processing units (CPUs) and may include any type of processor, such as a microprocessor, digital signal processor, microcontroller, programmable logic device (PLD), field programmable gate array (FPGA), or the like. The controller may also include a memory to store data and/or instructions that, when executed by the one or more processors, causes the one or more processors to perform one or more methods and/or algorithms. In example embodiments that employ a combination of multiple controllers and/or multiple memories, each function of the systems and/or methods described herein can be allocated to and executed by any combination of the controllers and memories.

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

Any of the herein described methods, programs, algorithms or codes may be contained on one or more non-transitory computer-readable or machine-readable media or memory. The term “memory” may include a mechanism that provides (in an example, stores and/or transmits) information in a form readable by a machine such a processor, computer, or a digital processing device. For example, a memory may include a read only memory (ROM), random access memory (RAM), magnetic disk storage media, optical storage media, flash memory devices, or any other volatile or non-volatile memory storage device. Code or instructions contained thereon can be represented by carrier wave signals, infrared signals, digital signals, and by other like signals.

The foregoing description is only illustrative of the present information systems. Various alternatives and modifications can be devised by those skilled in the art without departing from the disclosure. Accordingly, the present disclosure is intended to embrace all such alternatives, modifications and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A system for providing information to first responders during an emergency response, comprising:
a processor;
a display device; and
a memory storing instructions that, when executed by the processor, cause the system to:
obtain, from a plurality of data sources over a communication network, data related to a geographical address;
normalize the obtained data based on a normalization rule;
process the normalized data, wherein the processing includes identifying, based on at least one of a predetermined criterion or the normalized data, a user interface element to include in a user interface;
generate the user interface including the user interface element based on a result of the processing; and
cause the user interface to be displayed by way of the display device.

2. The system of claim 1, wherein the obtained data includes a plurality of data fields each having a corresponding plurality of data field values, and wherein the normalizing the obtained data includes:
extracting the plurality of data field values from the obtained data; and
based on the normalization rule, modifying the plurality of data field values, thereby generating a plurality of normalized data field values.

3. The system of claim 1, wherein the predetermined criterion includes a rule that indicates, based on a data field value of a data field included in the obtained data, whether to include a user interface element in the user interface.

4. The system of claim 1, wherein the user interface includes a textual description of a structure located at the geographical address.

5. The system of claim 4, wherein the textual description includes at least one of a number of floors of the structure, a date of construction of the structure, a material of which the structure is constructed, or an indication of whether the structure includes a solar panel.

6. The system of claim 1, wherein the user interface includes a plurality of alert icons, each alert icon belonging to a one of a plurality of alert icon categories and providing an alert corresponding to a structure located at the geographical address.

7. The system of claim 6, wherein the plurality of alert icon categories includes at least one of an occupancy category, a consideration category, a building construction category, a pre-plan category, a fire-suppression category, or a hazard category.

8. The system of claim 7, wherein
alert icons belonging to the occupancy category include an alert icon indicating an occupancy of the structure;
alert icons belonging to the consideration category include at least one of an alert icon indicating whether the structure includes a solar panel or an alert icon indicating whether a swimming pool is located at or near the structure; and
alert icons belonging to the building construction category include at least one of an alert icon indicating whether the structure is formed of a truss construction, an alert icon indicating whether the structure is formed of a concrete, or an alert icon indicating whether the structure includes roofing material.

9. The system of claim 7, wherein
alert icons belonging to the pre-plan category are generated based on data obtained from a pre-planning source;
alert icons belonging to the fire-suppression category include at least one of an alert icon corresponding to a sprinkler installation at the structure; and
alert icons belonging to the hazard category include an alert icon indicating whether any hazardous material is present at or near the structure.

10. The system of claim 6, wherein each of the plurality of alert icons is color-coded based on which one of the plurality of alert icon categories to which it corresponds.

11. The system of claim 1, wherein the user interface includes a plurality of selectable visual user interface elements, including at least one of a street view user interface element, a roof image user interface element, a property sketch user interface element, a hazardous material user interface element, a social media feed user interface element, a nearest cameras user interface element, or a nearest hydrants user interface element.

12. The system of claim 11, wherein the hazardous material user interface element is selectable, and wherein the memory stores further instructions that, when executed by the processor, cause the system to, in response to the hazardous material user interface element being selected, cause the user interface to display information regarding at least one of a type of hazardous material present at or near the geographical address, or a procedure for handling the type of hazardous material present at or near the geographical address.

13. The system of claim 1, wherein the user interface includes a plurality of data source-specific information sections, including at least one of a fire department section that provides information obtained from a fire department data source, a property assessor section that provides information obtained from a property assessor data source, a building department section that provides information obtained from a building department data source, a weather section that provides information obtained from a weather data source, a fire prevention section, a community section, or a government agency section.

14. The system of claim 13, wherein each of the plurality of data source-specific information sections is selectable and wherein the memory stores further instructions that, when executed by the processor, cause the system to, in response to one of the plurality of data source-specific information sections being selected, cause the one of the plurality of data source-specific information sections to toggle between an expanded state and a collapsed state.

15. The system of claim 13, wherein the user interface further includes a plurality of alert icons, each alert icon providing an alert corresponding to a structure located at the geographical address, and each alert icon being selectable, and wherein the memory stores further instructions that, when executed by the processor, cause the system to, in response to one of the plurality of alert icons being selected, cause the user interface to be scrolled to display one of the data source-specific information sections that corresponds to the selected one of the plurality of alert icons.

16. The system of claim 1, wherein the memory stores further instructions that, when executed by the processor, cause the system to:
obtain, from a dispatch system over a dispatch network, emergency call information regarding an emergency call placed regarding the geographical address, and
in response to the obtaining of the emergency call information, cause the system to commence at least one of the obtaining of the data related to the geographical address, the normalizing of the obtained data, the processing of the normalized data, or the generating of the user interface.

17. The system of claim 1, wherein the plurality of data sources includes at least one of a building department data source, an Internet platform data source, a utility company data source, a water department data source, a fire department data source, a municipal data source, a pre-plan records management system data source, an inspection records management system data source, a computer-aided dispatch data source, an Internet of Things-based data source, a fire prevention based data source, a community data source, or a government agency data source.

18. The system of claim 1, wherein the user interface includes:
a textual description of a structure located at the geographical address;
a plurality of alert icons, each alert icon providing an alert corresponding to a structure located at the geographical address; and
a plurality of data source-specific information sections.

19. A computer-implemented method for providing information to first responders during an emergency response, comprising:
obtaining, from a plurality of data sources over a communication network, data related to a geographical address;
normalizing the obtained data based on a normalization rule;
processing the normalized data, wherein the processing includes identifying, based on at least one of a predetermined criterion or the normalized data, a user interface element to include in a user interface;
generating the user interface including the user interface element based on a result of the processing; and
causing the user interface to be displayed by way of the display device.

20. A non-transitory computer-readable medium having stored thereon instructions that, when executed by a processor, cause the processor to implement a method for providing information to first responders during an emergency response, the method comprising:
obtaining, from a plurality of data sources over a communication network, data related to a geographical address;
normalizing the obtained data based on a normalization rule;
processing the normalized data, wherein the processing includes identifying, based on at least one of a predetermined criterion or the normalized data, a user interface element to include in a user interface;
generating the user interface including the user interface element based on a result of the processing; and
causing the user interface to be displayed by way of the display device.
